(19) United States
(12) Patent Application Publication
(10) Pub. No.: US 2019/0031346 A1
(43) Pub. Date: Jan. 31, 2019

(54) SYSTEM AND METHOD FOR CONTROLLING AN UNMANNED VEHICLE AND RELEASING A PAYLOAD FROM THE SAME

(71) Applicant: GARUDA ROBOTICS PTE. LTD., Singapore (SG)

(72) Inventors: Chuen-Tze Mark YONG, Singapore (SG); Jiin Joo ONG, Singapore (SG); Jia Jun Nicholas Emmanuel HON, Singapore (SG); Jax Jiaxin CHEN, Singapore (SG); Yoon Chun Nicholas NG, Singapore (SG); Jun Bei Rex TAN, Singapore (SG); Iryanto JAYA, Singapore (SG)

(73) Assignee: GARUDA ROBOTICS PTE. LTD., Singapore (SG)

(21) Appl. No.: 16/073,767

(22) PCT Filed: Jan. 27, 2017
(86) PCT No.: PCT/SG2017/050042

§ 371 Date: Jul. 27, 2018

(30) Foreign Application Priority Data
Jan. 29, 2016 (SG) 10201600742Q

(51) Int. Cl. B64C 39/02; G05D 1/00; G05D 1/02; G08G 5/00; B64D 1/08; B64D 1/18; A01C 21/00; A01C 23/04; A01M 7/00; A01G 25/09; B64F 1/36; B64F 1/32; B05B 15/60

(52) U.S. Cl. CPC B64C 39/024; H04L 67/12; G05D 1/0027; G05D 1/0202; G08G 5/0043; G08G 5/0013; G08G 5/0082; G08G 5/006; G08G 5/0086; B64D 1/08; B64D 1/18; A01C 21/005; A01C 23/047; A01M 7/0042; A01G 25/09; B64F 1/362; B64F 1/32; B05B 15/60; B64C 2201/208; B64C 2201/123; B64C 2201/146; B64C 2201/027; B64C 2201/108; B64C 2201/128; G05D 1/0016

(57) ABSTRACT

Aspects of the invention include a system for managing an agriculture plantation comprising a plantation information management server operable to send at least one electronic request to manage the agricultural plantation, the at least one electronic request comprises at least one target within the agricultural plantation; a central processor arranged in data communication with the plantation information management server to receive the electronic request to form a first dataset; the first dataset comprises data related to a size, a location and the at least one target within the agricultural plantation; an unmanned vehicle command and control server arranged in data communication with a plurality of base stations to deploy the plurality of base stations at predetermined locations within the agricultural plantation; each of the plurality of base stations arranged in data communication with at least one unmanned vehicle; the unmanned vehicle command and control server further arranged in data communication with the central processor to receive a second dataset related to at least one operation of the at least one unmanned vehicle; and a block segregator arranged to receive the first dataset as input to generate an output, the output comprises data related to the division of the agricultural plantation into a plurality of smaller areas.

### FIELD OF THE INVENTION

The present invention relates to a system and method for controlling an unmanned vehicle, which includes but is not limited to an unmanned aerial vehicle (UAV) and releasing a payload from the same.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Unmanned Aerial Vehicles (UAVs) are increasingly used in remote, dangerous, inconvenient, or inaccessible environments, most commonly by releasing a designated object on a target in a relatively inaccessible area. To increase the chances of a successful intervention while ensuring the safety and protection of humans, assets and the environment, the UAV pilot will require additional help, mostly by advanced algorithms but also another person/user who might have a better idea of the target location than the UAV pilot.

Examples of such interventions include but are not limited to: dispensing treatment solutions into water bodies, spraying pesticides on individual crops, delivering a life-saving device to a person, and more.

The present invention seeks to meet the above needs and improve the deployability of unmanned vehicles in remote, dangerous, inconvenient, or inaccessible environments at least in part. In addition, the invention also seeks to provide a solution for managing remote or inaccessible environment such as, but not limited to agricultural plantations.

### SUMMARY OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

The invention comprises an unmanned vehicle, preferably an unmanned aerial vehicle (“UAV”) designed and configured to intervene in a remote environment, by using a variety of autonomous and/or remotely-triggered behaviours to safely and accurately deliver a payload to one or more target destinations. The UAV uses a combination of sensors, computer systems, and human agents nearby the targets to assist the UAV pilot in identifying and tracking targets before dropping payloads on target. The release of the payload may take place while the UAV is in the air or when it has landed at the target.

In accordance with an aspect of the invention there is a system for controlling an unmanned aerial vehicle (UAV) and releasing a payload from the same comprising a UAV having at least one container for storing at least one payload; at least one release mechanism for releasing the payload; at least one image capturing device for capturing a plurality of images; the image capturing device in data communication with at least one processor, wherein the processor is operable to obtain the plurality of captured images from the image capturing device, compare each of the plurality of images with a feature model database and identify whether there is an available feature model and if there is an available feature model, whether the feature model matches at least one aspect of the target destination for releasing the payload.

Where there is no feature model available, the processor is operable to generate a feature model using a computer vision algorithm and thereafter compiles a list of features. The list of features may comprise at least one of the following: colour, colour gradient, intensity.

The processor may be operable to use a subset of the plurality of captured images for machine learning.

The processor may be operable to generate a flight path for the UAV where there comprises multiple targets. Such a flight path may be optimized based on deterministic or heuristics methods.

The processor may be operable to track or follow a user-specified target or an identified target. The tracking includes moving the image capturing device and/or the UAV such that the specified or identified target is at the centre of the image to be captured. Such movement may include rotation of the image capturing device about a fixed point, and/or sliding the image capturing device relative to the UAV.

The control of the UAV may be performed by at least one pilot. In some instances, the at least one pilot may be assisted by a trained agent who is provided with limited control of the UAV. Such limited control may be restricted to the landing and/or taking off of the UAV.

In accordance with another aspect of the invention there is an unmanned aerial vehicle (UAV) configured to release a payload at a target destination, the UAV having at least one container for storing at least one payload; at least one release mechanism for releasing the payload; at least one image capturing device for capturing a plurality of images; at least one processor arranged in data communication with the image capturing device, wherein the processor is operable to obtain the plurality of captured images from the image capturing device, compare each of the plurality of images with a feature model database and identify whether there is an available feature model and if there is an available feature model, whether the feature model matches at least one aspect of the target destination for releasing the payload.

In accordance with another aspect of the invention there is a method of controlling and releasing a payload from an unmanned aerial vehicle (UAV) comprising the steps of: receiving from a remote controller via a wireless communications channel, an electronic signal to trigger the UAV to capture a plurality of images; capturing a plurality of images using at least one image capturing device; comparing each of the plurality of images with a feature model database; identifying whether there is an available feature model and wherein if there is an available feature model; determining whether the feature model matches at least one aspect of the target destination for releasing the payload.

In accordance with another aspect of the invention there is a non-transitory computer readable medium storing a program causing an on board computer on the UAV to execute a method for controlling and releasing a payload from an unmanned aerial vehicle (UAV), the method comprising receiving a electronic signal via a wireless communications channel to trigger the UAV to capture a plurality of images; capturing a plurality of images using at least one image capturing device; comparing each of the plurality of images with a feature model database; identifying whether there is an available feature model and wherein if there is an available feature model; determining whether the feature model matches at least one aspect of the target destination for releasing the payload.

In accordance with another aspect of the invention there comprises at least one mobile device having a non-transitory computer readable medium storing a program causing the mobile device to function as a remote controller for controlling and releasing a payload from an unmanned aerial vehicle (UAV).

In accordance with another aspect of the invention there comprises a system for managing an agriculture plantation comprising a plantation information management server operable to send at least one electronic request to manage the agricultural plantation, the at least one electronic request comprises at least one target within the agricultural plantation; a central processor arranged in data communication with the plantation information management server to receive the electronic request to form a first dataset; the first dataset comprises data related to a size, a location and the at least one target within the agricultural plantation; an unmanned vehicle command and control server arranged in data communication with a plurality of base stations to deploy the plurality of base stations at predetermined locations within the agricultural plantation; each of the plurality of base stations arranged in data communication with at least one unmanned vehicle; the unmanned vehicle command and control server further arranged in data communication with the central processor to receive a second dataset related to at least one operation of the at least one unmanned vehicle; and a block segregator arranged to receive the first dataset as input to generate an output, the output comprises data related to the division of the agricultural plantation into a plurality of smaller areas.

In some embodiments, the first dataset further comprises at least one of the following information related to the agricultural plantation: terrain, transportation route, planned locations of the plurality of base stations.

In some embodiments, the block segregator is configured to optimize the number of smaller areas.

In some embodiments, the at least one of the unmanned vehicle is an unmanned aerial vehicle.

In some embodiments, at least one of the plurality of base stations is a mobile base station and at least one of the plurality of base stations is a static base station. The at least one static base station may be deployed within one of the plurality of smaller areas and arranged in data communication with the mobile base station.

In some embodiments, the central processor is arranged in data communication with a schedule database, the schedule database operable to store at least one schedule related to the at least one operation of the at least one unmanned vehicle.

In some embodiments, the system further comprises an airspace management and air traffic control module arranged in data communication with the plurality of base stations and the at least one unmanned aerial vehicle. The airspace management and air traffic control module is operable to segregate the region which the at least one unmanned aerial vehicle operates within into a plurality of airspaces.

In some embodiments, the plurality of airspaces comprises a first airspace measured from ground level to a reference point plus a first predetermined distance above the reference point. In some embodiments, the system further comprises a second airspace extending by a second predetermined distance above the first airspace.

In some embodiments, the system further comprises a third airspace extending by a third predetermined distance above the second airspace.

In some embodiments, the at least one operation of the at least one unmanned aerial vehicle comprises dropping a payload over an area or an object within the smaller area. In some embodiments, the plurality of base stations are operable to receive information relating to the plurality of airspaces to control the at least one unmanned aerial vehicle within the first airspace to drop the payload.

In some embodiments, the base station is operable to control the UAV to operate within the second airspace after dropping the payload to return to the base station. In some embodiments, the block segregator is arranged in data communication with at least one of the plurality of unmanned vehicle to receive at least one image relating to the geographical surrounding the unmanned vehicle operates within.

In some embodiments, there comprises a plurality of mobile base stations, each mobile base station operable to data communicate with other mobile base stations to relay data. Such an arrangement is advantageous to form a relay chain or link in case a mobile base station is unable to communicate with a static base station.

In some embodiments, the data communication between the unmanned vehicle command and control server and the plurality of base stations is facilitated via a network operator.

In some embodiments, a mobile device is arranged in data communication with the unmanned vehicle to control the at least one unmanned vehicle near the vicinity of the at least one target.

In some embodiments, the system further comprises a target image database to store a plurality of images determined to be visually similar to the at least one target.

In some embodiments, the target image database is operable to store a plurality of images determined not to be targets.

In some embodiments, the plurality of images determined to be targets and determined not to be targets is fed as an input dataset into a machine-learning algorithm to build an internal model of the target.

In accordance with another aspect of the invention there is an unmanned aerial vehicle for use with the system, comprising a propulsion device operable to move the unmanned vehicle, a communication module operable to facilitate data communication between the unmanned aerial vehicle with at least one of the base stations, an image capturing device operable to capture image; a payload storage tank; and a payload dispensing mechanism.

In some embodiments, the payload dispensing mechanism is shaped and adapted to dispense payload on a point target or an area target.

In some embodiments, the payload dispensing mechanism comprises a plurality of nozzles taking reference to a centre nozzle.

In some embodiments, the plurality of nozzles are pointed towards the centre nozzle for releasing a fluid payload at the point target.

In some embodiments, the plurality of nozzles are pointed outwards from the centre nozzle for releasing a fluid payload at the area target.

In some embodiments, the static base station further comprises a recharging pod, a refill pod, a payload supply, a communication device for data communication with at least one mobile base station and the unmanned vehicle command and control server, and a processor server in data communication with the schedule database. In some embodiments, the mobile base station further comprises a recharging pod, a refill pod, a payload supply, a communication device for data communication with at least one unmanned aerial vehicle, and a processor server in data communication with the schedule database.

In accordance with another aspect of the invention there is a method for managing an agriculture plantation comprising the steps of:—receiving from a plantation information management server, at least one electronic request to manage the agricultural plantation, the at least one electronic request comprises at least one target within the agricultural plantation; forming a first dataset; the first dataset comprises data related to a size, a location, and the at least one target within the agricultural plantation; generating, based on the first dataset as input, an output, the output comprises data related to the division of the agricultural plantation into a plurality of smaller areas; sending a second dataset to an unmanned vehicle command and control server, the second dataset related to at least one operation of at least one unmanned vehicle; and deploying, via the unmanned vehicle command and control server, a plurality of base stations at predetermined locations within the agricultural plantation; each of the plurality of base stations arranged in data communication with at least one unmanned vehicle.

In some embodiments, the first dataset further comprises at least one of the following information related to the agricultural plantation: terrain, transportation route, planned locations of the plurality of base stations, actual location of at least one of the plurality of base station.

In some embodiments, the method further comprises the step of optimizing the number of smaller areas.

In some embodiments, the method further comprises the step of generating a schedule based on the at least one target within the agricultural plantation, and storing the generated schedule by a schedule database.

In some embodiments, there further comprises an airspace management and air traffic control module arranged in data communication with the plurality of base stations and the at least one unmanned aerial vehicle. In some embodiments, the method further comprises the step of segregating, by the airspace management and air traffic control module, the region which the at least one unmanned aerial vehicle into a plurality of airspaces. The plurality of airspaces may comprise a first airspace measured from ground level to a reference point plus a first predetermined distance above the reference point. The plurality of airspaces may further comprise a second airspace extending by a second predetermined distance above the first airspace. The plurality of airspaces may further comprise a third airspace extending by a third predetermined distance above the second airspace.

In some embodiments, the method further comprises the step of loading a plurality of unmanned aerial vehicles and generating an optimal flight path after the step of deploying the plurality of base stations.

In some embodiments, the method further comprises the step of moving the unmanned aerial vehicle within the first airspace to the at least one target.

In some embodiments, the method further comprises the step of locating, by an image capturing device mounted on the unmanned aerial vehicle, the at least one target.

In some embodiments, the method further comprises the step of releasing a payload on the at least one target.

In some embodiments, the further comprises the step of collecting a status associated with the release of payload.

In some embodiments, the method further comprises the step of moving the unmanned aerial vehicle into the second airspace, and moving away from the target and towards the base station after the step of releasing the payload.

In some embodiments, the method further comprises the step of maintaining the unmanned aerial vehicle.

In some embodiments, the method further comprises the step of generating and synchronizing collected data to be sent to the base station.

In some embodiments, the step of generating the optimal flight path comprises utilizing at least one of the following as an objective function: minimize distance between the unmanned aerial vehicle and the target; minimize power consumption of the unmanned aerial vehicle; subjected to the constraints of no-fly zones and obstacles.

### BRIEF DESCRIPTION OF THE DRAWINGS

The present invention will now be described, by way of example only, with reference to the accompanying drawings, in which:

FIG. 1 is a diagram illustrating an embodiment of the invention.

FIG. 2 is a flowchart for generating a safe flight path to guide a UAV autonomous flight in accordance with some embodiments of the invention.

FIGS. 3a and 3b are flowcharts relating to the learning and identification of a target, in accordance with some embodiments of the invention;

FIG. 4 is a flowchart for tracking a specified target by visually recognising the target based on the camera's video inputs in accordance with some embodiments of the invention; and

FIG. 5 is a flowchart for setting a UAV's camera to enter a “Track” mode where the camera will be fixated at the target in the centre of the live video stream.

FIG. 6 is a legend for FIGS. 7 to 34.

FIG. 7 is a system overview diagram illustrating an embodiment of the invention.

FIG. 8 is an architecture diagram of the Master/Local Scheduler of the invention.

FIGS. 9a to 9c are illustrations of the structure of the UAV, its spray/dispersal system and reservoir respectively.

FIG. 10 is a diagram illustrating the UAV localization with its camera.

FIG. 11 is an architecture diagram of a static base station.

FIG. 12 is an architecture diagram of a mobile base station.

FIG. 13 illustrates the dynamic block partitioning of an embodiment of the invention.

FIG. 14 is an architecture diagram of the computer system of an embodiment of the invention.

FIG. 15 is an architecture diagram of the computer network of an embodiment of the invention.

FIG. 16 is an illustration of a manual guidance application interface for a pilot/agent to manually control a UAV.

FIG. 17 is a sample request form filled in by an arborist in the Plantation Information Management System (PIMS) of the invention.

FIG. 18 is a scheduler interface of an embodiment of the invention.

FIG. 19 is an Unmanned Vehicle Command and Control (UVCC) interface of an embodiment of the invention.

FIG. 20 illustrates airspace segregation for airspace management of UAVs of the invention.

FIG. 21 is an air traffic control diagram of an embodiment of the invention.

FIG. 22 is a ground traffic control diagram of an embodiment of the invention.

FIG. 23 is an operations workflow of an embodiment of the invention.

FIG. 24 is a flowchart of a UAV workflow of the invention.

FIG. 25 is a flowchart of the generation of flight paths and selection of an optimal flight path of a UAV an embodiment of the invention.

FIG. 26 illustrates UAV launch and recovery from a base station of an embodiment of the invention.

FIG. 27 is a workflow of visual target detection by a UAV of an embodiment of the invention.

FIG. 28 is a workflow for manual guidance by a pilot/agent of a UAV of an embodiment of the invention.

FIG. 29 illustrates real-time correction made by a pilot/agent via a mobile device in communication with a UAV of an embodiment of the invention.

FIG. 30 illustrates an intervention by a UAV of an embodiment of the invention.

FIG. 31 illustrates refilling of a UAV reservoir at a base station.

FIG. 32 is a flowchart of training of UAVs using machine learning techniques.

Other arrangements of the invention are possible and, consequently, the accompanying drawings are not to be understood as superseding the generality of the description of the invention.

### DESCRIPTION OF EMBODIMENTS OF THE INVENTION

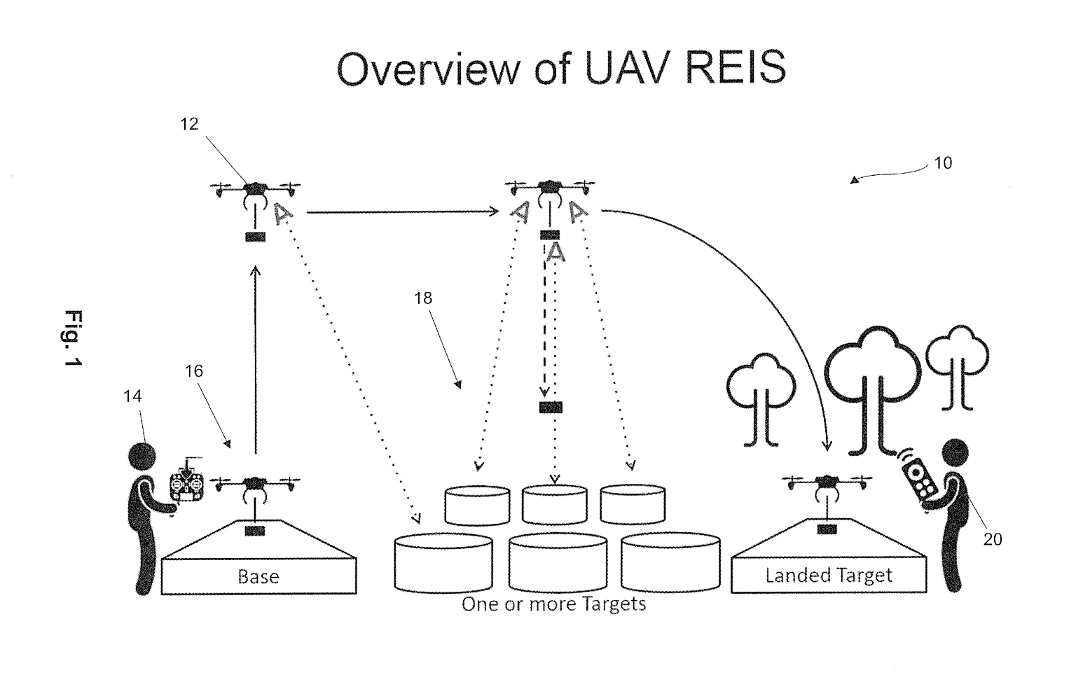

In accordance with an embodiment of the invention and with reference to FIG. 1, there comprises a system 10 for releasing a payload from an unmanned aerial vehicle. The system 10 comprises a UAV 12 operable by a pilot 14 from a first location 16 to a second location 18. The pilot 14 may operate the UAV 12 using a mobile device such as, but not limited to, a smartphone or a tablet PC. The UAV 12 and/or the mobile device is in data communication with one or more servers, processors and/or databases. These servers, processors and/or databases are information sources for obtaining information relating to the flight and operation of the UAV.

There may comprise one or more UAV pilots situated at a base 16 as the first location. There may comprise one or more recipient user, hereinafter referred to as agent(s) 20 situated in the vicinity of the second location 18, which is the target location. The base 16 may be a location or facility comprising take-off/landing pads, where payloads can be properly loaded onto the UAV, and where UAVs can take off and land.

The UAV is typically in the form of a multi-rotor vehicle or a variant of such multi-rotor systems that is capable of hovering in airspace. The UAV comprises one or more of the following features:
A Controlled Release Mechanism that comprises containers attached to the UAV, with lids and motorised trapdoors, and that can carry and release a suitable payload on command. Non-exhaustive examples of arrangement of containers with lids, motorised trapdoors may further comprise a latch. The trapdoor may be one or more of the following: (i) simple door; (ii) slide; (iii) spray nozzle.
The lid and container arrangement may be one of the following (i) no lid (open pocket); (ii) simple lid; (iii) pressurised air chamber.
A gimbal-stabilized camera or a system of cameras or any form of imaging capturing device, at least one of which is capable of capturing video for various purposes. Such videos can then be utilized by the mobile device or a computer device in data communication with the mobile device or UAV to assist the pilot and UAV in the flight.
A power system for the UAV and corresponding power recharging systems. The power systems may be connected to the computer on board the UAV for detection of power level and whether it is capable of making the next trip to the next target location.
A computer on board the UAV with a combination of positioning and localization sensors such as GPS sensors and Inertial Measurement Units, that is capable of executing autonomous flight, executing computer implemented methods based on video inputs from cameras, and triggering the release mechanism.

In some embodiments, the computer on board the UAV is connected to the other features as mentioned above and is operable to receive data/communication signals from the various features to make a decision. For example, the computer makes decisions based on the battery levels it reads from the power system.

The mobile device functions as a remote control system comprising one or more transmitters to control the UAV's flight, the onboard camera's orientation and the release mechanism. The mobile device for the UAV pilot may further comprise a computing device for the UAV pilot to display the video live stream from the camera and telemetry data required by the UAV pilot 14. In some embodiments, the mobile device may be integrated with the computing device for the display of the video live stream. In other embodiments, the mobile device may be independent from the computer device or in remote data communication with the computer device.

In some embodiments, the system comprises a wireless communication system established between the mobile remote controller and the UAV to enable data transfer and data communication among UAVs, transmitters and computers.

In some embodiments, the system comprises a video streaming system capable of making video(s) captured by cameras available through the wireless communication system.

In some embodiments, the system comprises a UAV fleet management system that helps the UAV pilot or pilots track the location of UAVs through the active broadcast of their location back to the system. This is particular useful in embodiments where there comprises a plurality of UAVs within the system managed or operated by a plurality of UAV pilots. In particular, regardless of the mode of operation, i.e. manual or automatic, the UAV is consistently broadcasting telemetry data through the wireless communication system to the UAV pilots' computing device, and relayed to the UAV fleet management system, the management system also known as a unmanned vehicle command and control server (UVCC) which may be one or more servers or processors in data communication with the UAV pilots' computing devices. Telemetry data includes the position and the heading of the UAV and camera, all electrical inputs to the UAV computer from sensors, and all electrical outputs from the UAV computer to the motors and release mechanisms.

The UAV fleet management system may further serve as an information repository for high-level coordination. This is particularly useful if multiple UAVs are in flight at the same time in adjacent air space. If two UAVs come too close to each other, it will warn the respective pilots to take precaution.

At different stages of operation, the UAV may require information about the environment that affects the flight of the UAV or the release of the payload, including but not limited to, real time GPS signals, updated maps with terrain info, current and forecasted weather (wind, rain), target location, target matter, etc.

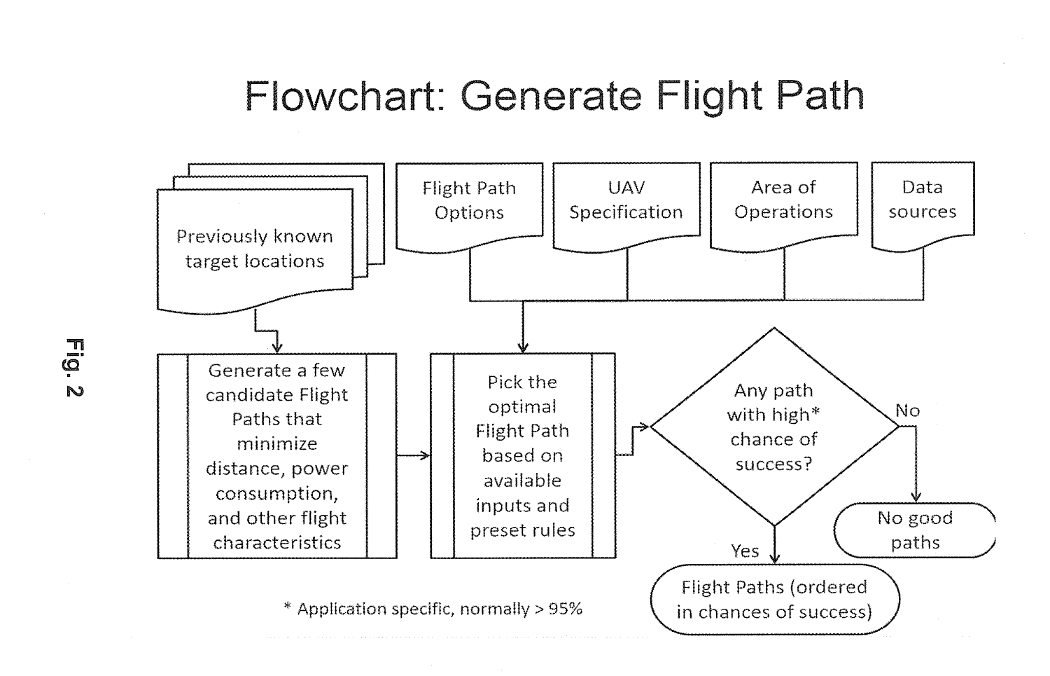

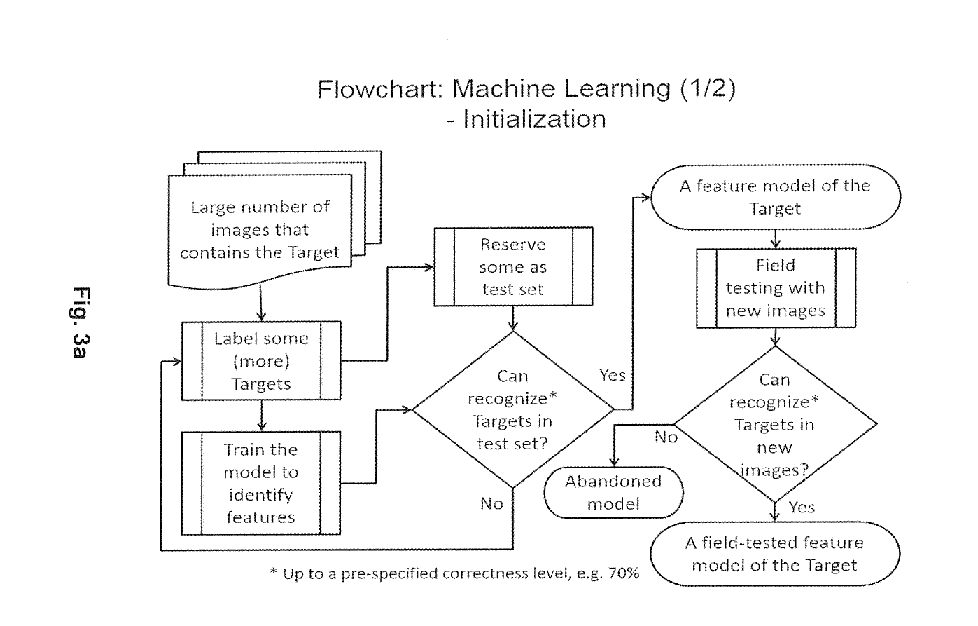

The operation of the UAVs, including take-off, landing and flight path, may be controlled by one or more algorithms implemented using one or more computer implemented programs or methods. Examples of the computer implemented programs or methods include one or more of the following:
A computer implemented method that directs the UAV to fly autonomously from its current position to another geographically referenced location and altitude;
A computer implemented method that generates a safe flight path to guide the UAV's autonomous flight (see FIG. 2);
A computer implemented method that learns to identify the target, both through human provided inputs as well as machine learning methods of studying many examples of the target (see FIGS. 3a and 3b).
A computer implemented method that tracks the specified target by visually recognising the target based on the camera's video inputs (see FIG. 4);
A computer implemented method that determines when to activate the release mechanism automatically based on its computed model and accuracy. The method includes a step of error tolerance measurement.
A computer implemented method that allows target areas to be automatically marked out, including target types within the area, characteristics of the target type and other intelligence gathered. This typically includes the step of a database look up, the database comprising data related to various features.
A computer implemented method that computes the most efficient path to deliver the payload to all marked targets, based on the characteristics of a UAV. This may be based on deterministic or heuristic algorithms utilized to solve problems such as the traveling salesman problem, which the flight path could be modelled after.
A computer implemented method that constantly re-evaluates its ability to complete the delivery of the payload to all the targets. This may include utilization of an expert or rule-based system.

In some embodiments, an UAV pilot may be required to handover control to one or more agents. In such situations, a control passing system may be utilized to do so.

The control passing system may include a software installed on a mobile device in the form of a dedicated software application, colloquially known as an ‘app’. The dedicated software application allows an agent who is expecting the payload to communicate with the pilot about his/her readiness to take over the landing process, officially take over primary control to guide the UAV to land safely, and handing back control of the UAV to the pilot once the UAV has taken off back to a safe altitude away from obstacles. Further, the dedicated software application may include a computer implementation method of transmitting the live video feed from the camera on the UAV that will help the pilot assess the remote situation where the agent is intending to land the UAV, establishing the necessary trust for the hand over and providing continuous guidance to the agent.

The system, and the interaction of the various described components, will next be described in the context of operation, i.e. as a method controlling the UAV and releasing payload from the same.

The process begins with an intention to intervene. As used throughout the specification, the terms “intervene”, “intervention” and “intervening” refer to the use of a variety of autonomous and/or remotely-triggered behaviours by an unmanned vehicle to safely and accurately deliver and/or release a payload to/at one or more target destinations. In an embodiment where the unmanned vehicle is a UAV, intervention includes the discharge of a payload substantially above a target, where the payload can be passively delivered to the target via gravity and/or prevailing environmental conditions, e.g. wind direction, and/or actively delivered to the target by controlled and targeted spraying.

One or more suitable payloads are selected and loaded into the controlled release mechanism of the UAV, with each payload stored in a container within the mechanism. Each payload is loaded such that it will, upon the opening of the trapdoor, fall vertically downwards or towards the ground under the influence of gravity, depending on factors such as weight of payload and prevailing wind/air conditions. In the event that the payload is a liquid, it will be sprayed towards the target (usually in a downward direction) in a controlled manner through a nozzle. More than one such controlled release mechanism can be detached, pre-loaded and re-attached to the UAV for efficient preparation, especially in the case where UAVs need quick turn-around for the next flight.

The UAV pilot goes through pre-flight safety checks, including the step of ensuring the payload is secure. Once the verification is complete, the pilot places the UAV at the base, which can be an open space suitable for take-off and landing. At this point, depending on the application and situation, the UAV pilot may choose a completely autonomous delivery, a completely manual one, or some combination of autonomous and manual behaviours as described in the subsequent sections.

If the pilot chooses a completely manual mode, the UAV pilot can manually pilot the UAV to a location where he can still maintain Visual Line Of Sight (VLOS) of the UAV. Additionally, the UAV pilot is able to use the live video streaming from the camera on the UAV to identify and approach the target.

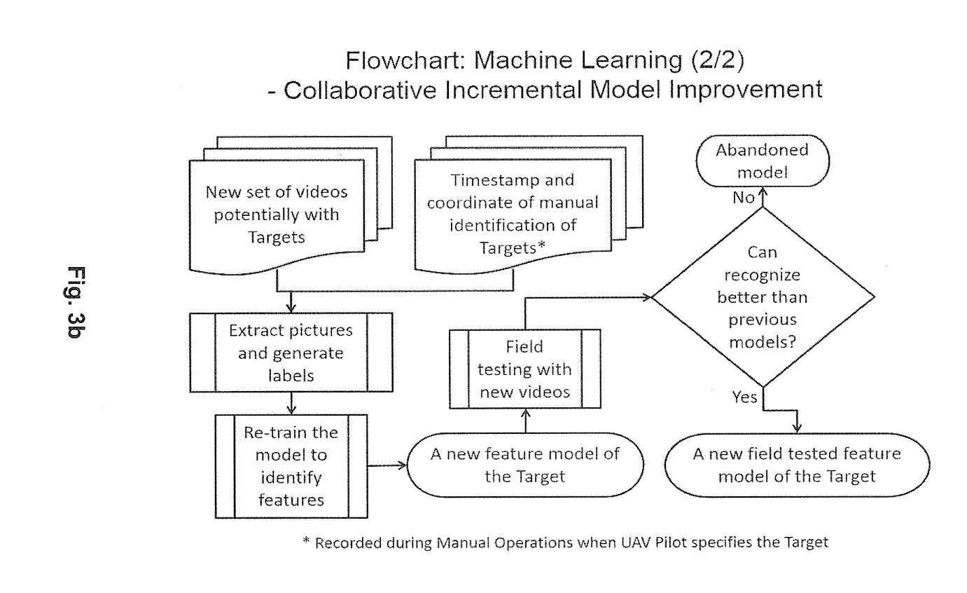

To help the pilot fly the UAV towards the target, the pilot can remotely set the UAV's camera to enter a “Track” mode where the camera will be fixated at the target in the centre of the live video stream (see FIG. 5). This is accomplished by applying a target detection algorithm that constantly adjusts the gimbal holding the camera, such that the target identified remains in the centre of the screen for the pilot. The pilot also has the option to re-centre and re-select the target as the UAV approaches the target and progressively obtains a higher resolution view of the target.

The pilot would fly the UAV until the gimbal is pointing directly downwards from the UAV. This indicates that the UAV is directly above the target. Under little or no wind condition, releasing the payload at this moment would accurately drop the payload on the target.

Once the pilot is confident, he or she will remotely arm and trigger the release mechanism to open the trapdoor. A deliberate arming step ensures that the mechanism will not be accidentally triggered.

The pilot might also use his awareness of the surroundings to manoeuvre the UAV into a more favourable position prior to commanding the release of a payload. The pilot can release one or more payloads at once. The pilot can subsequently fly the UAV to the next target, or return to base to recharge batteries and reattach new payloads.

In some embodiments, the UAV pilot can use an alternative method to release the payload. Upon reaching the vicinity of the target, the pilot first ensures the altitude of the UAV is safe for autonomous flight, sets the camera into the “Track” mode, then arms the release mechanism, and sets it to “Release above Target”.

When the ‘release above target’ mode is activated, the UAV will make its own flight decisions based on the gimbal position, and nudge itself horizontally until it is directly above the target, and release the payload shortly upon arrival. The pilot monitors the entire operation, and is capable of abandoning the auto release at any point in time by disarming the release mechanism, or regaining manual flight controls simply by utilizing his or her transmitter.

The system 10 as described so far is suitable for one-off targets that could only be discerned either by the UAV pilot, or by a target detection algorithm. For repeated targets that look similar, such as the canopy of a tree crop, a machine-learning algorithm can be applied to enhance the target detection algorithm, by learning from multiple positive examples of the target.

To put this into practice, images of a large number of visually similar targets are captured and tagged as positive samples. Images of non-target objects may also be captured and tagged as negative samples. The machine-learning algorithm uses the examples to build an internal model of the target (stored in a target database). The model is then loaded into the UAV's computer as a reference model for the target detection algorithm to use.

With the model, the UAV pilot does not need to centre the target in the camera's view to select the target. The UAV simply determines the target as it comes into the view of the camera via a lookup on the target database. The pilot can similarly allow the computer to perform the automatic release, or command the release manually.

In situations where the repeated targets are found in a contiguous area, the UAV pilot can specify an area by marking out a polygon on a map (bounded area of operation), and command the UAV to complete an autonomous flight over the area. The pilot's computing device will design a flight path that is most efficient to cover the area visually, such as a zigzag pattern, and give the flight instructions to the UAV.

During the flight, the UAV's camera points downwards, while the UAV's computer looks out for the next target. The zigzag flight path is designed to have the downward facing UAV camera having ample information in at least one image captured to recognize the target, such as seeing an overlap between each row of at least the size of the target.

When the target is found, it will move towards the target until it's directly above it. If the UAV is allowed to release the payload on its own, it will do so and move back to the flight path to continue its search for the next target, until its payloads are exhausted, or it deem it only have enough power to return to base. Otherwise, it will stay above the target until the pilot commands it to release the payload or skip this target.

The above scenario can be further optimized if the UAV does not need to spend additional power to travel out of the flight path to drop the payload, by designing the flight path such that it crosses as many previously known target locations as possible. A database of all known targets can be provided to the flight path designer algorithm in the form of a predetermined or saved target electronic file. When the pilot specify the area of operation, the flight path will be first optimized to cover all previously known targets, then extended to comb areas that have no previously known targets. In flight, the UAV will still utilize the model made by the machine learning algorithm and the real time target detection algorithm to identify the actual targets. A new database of these targets will be created based on the latest observation from the UAV. After the flight, the pilot has the opportunity to ignore, replace or merge the database of targets in preparation for the next flight.

Based on the saved targets over a period of time (or latest predetermined number of targets), the pilot has the option of pre-specifying which targets to drop the payload to, instead of dropping on all targets. In this case, the flight algorithm will ignore the bounded area of operation, and build the optimized flight path solely based on the selected targets.

In some embodiments, where payload cannot be released mid-air due to the fragile nature of the same, for example because the payload might shatter upon impact, or it's meant to be picked up by a person or animal. For such payloads, the UAV will have to land, release the payload, and take off again to return to base.

For such fragile payloads, the flight path design algorithm will take into account the relatively large sums of power consumed for an additional landing and take off. The UAV pilot can additionally specify a maximum transit time at the target, before it has to take off or risk losing too much power to return to base successfully. The algorithm will also take into account atmospheric and/or environmental factors such as weather and wind conditions and its impact on the performance characteristics on the UAV.

As examples, for assessing the UAV's capacity for withstanding wind, a wind tolerance profile is built through repeated testing of the UAV. For example, in a controlled environment such as a wind tunnel, a constant wind speed of, say 20 knots can be generated, and the battery drainage can be profiled when the UAV tries to counter such winds to stay in position. For rain: it's typically done by taking into account highly granular weather data and doing short term forecasting. For example, if the UAV (via its onboard computer system) notice a fast approach rain cloud in the last few readings, it would forecast when the rain cloud hits the flight path to decide whether it's a go-ahead or a no-go ahead. If the data is insufficient, example from weather sources, it will simply evaluate the situation by operational blocks (basically, if the weather information source says it will rain during the operations, the algorithm will not approve the plan to fly the UAV).

The UAV pilot has the option of a manual descent (if he has VLOS), or an automatic descent.

If the pilot does not have VLOS of the UAV, it's very difficult for him to command a landing and take-off solely based on live video streaming, especially if there are obstacles such as trees or buildings around the target. For safety reasons, the system requires a 3rd party 20 (i.e. agent) who has VLOS of the UAV to guide the landing and take-off.

The agent 20 located at the target destination (i.e. second location) will require a computing device that is capable of wireless communication to be able to interact with the UAV, and mobile wireless communication, to be able to interact with the UAV pilot and the remote control system. The agent 20 will also require some basic training about UAV flight characteristics and on how to operate the computing device prior to this activity. In some embodiments, the agent 20 utilizes a mobile device comprising a dedicated software app installed on a smartphone for assisting in the landing and take-off for the trained agent. In such cases, the trained agent uses a smartphone with the app installed for controlling the UAV. Such mobile device should have the following minimum hardware requirements, including wireless communication means such as Wi-Fi and 3G/4G, GPRS, LTE etc.

When the UAV is in the vicinity of the target, the UAV pilot and the agent will both be alerted. Both will be able to see the video stream from the UAV for added situational awareness. The UAV pilot then communicates with the agent to ensure that he or she is ready to take over the landing process. Once the pilot is certain, he will pass the control of the UAV to the agent.

It is to be appreciated that the agent has limited control of the UAV—he or she can halt the descent, nudge the UAV horizontally in all directions by a suitable or predetermined distance, for example three (3) metres each time, and continue the descent. Once the UAV touches the ground, it will gradually disarm on its own without the intervention of the agent, and subsequently release the payload. The agent can then approach the UAV to collect the payload.

After collection, the agent should move the UAV to a safe position for take-off. After moving away from the UAV, the agent will use his computing device to start the take-off process. The UAV will take-off vertically back to the altitude where the handover happened earlier, and notify the pilot to take back control. The agent has similarly limited control—he or she is able to pause the take-off, nudge the UAV, and continue the take-off procedure.

After taking back control, the UAV pilot can instruct the UAV to continue to the next target, or return to base.

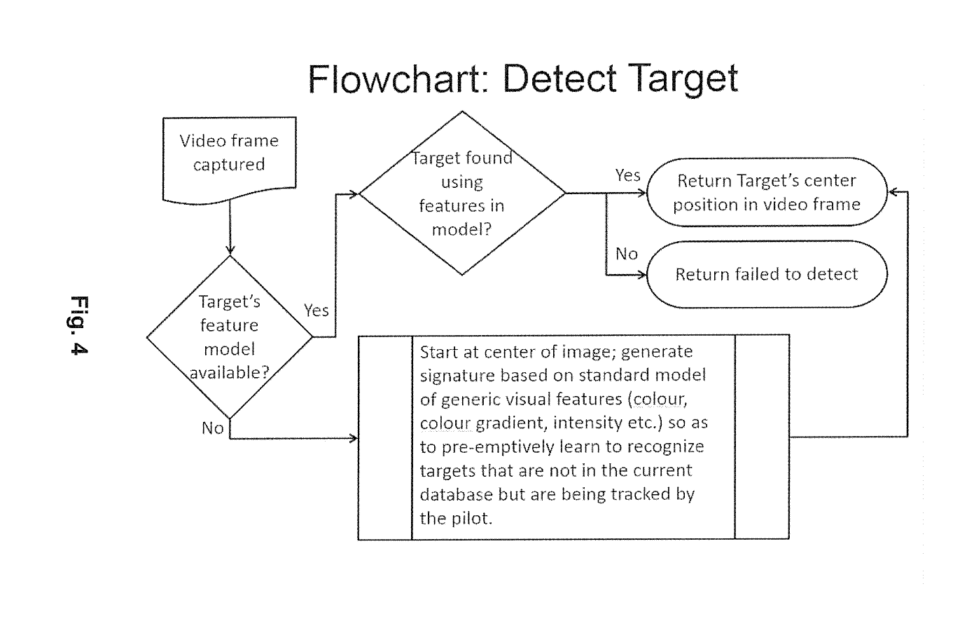

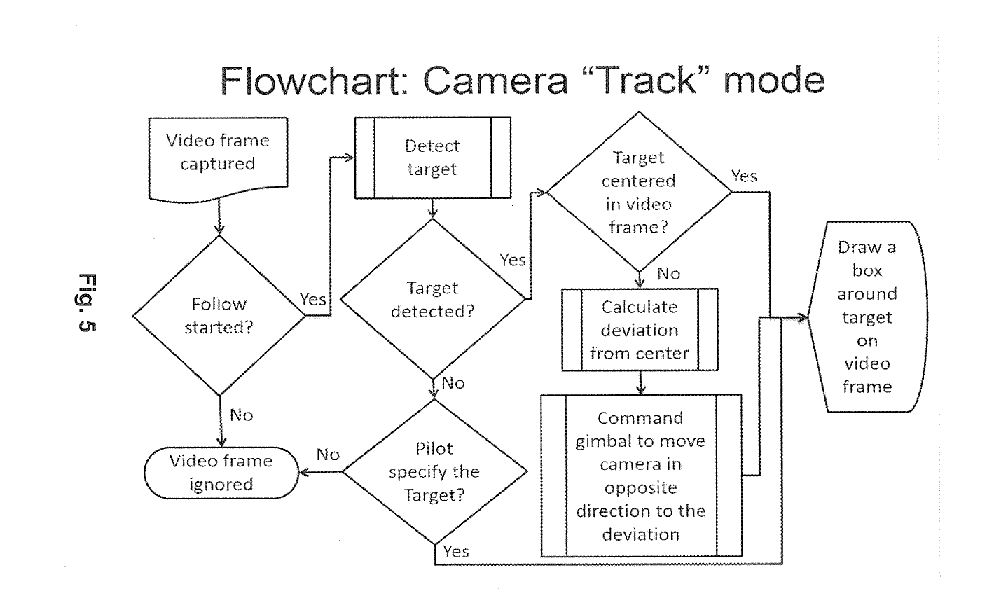

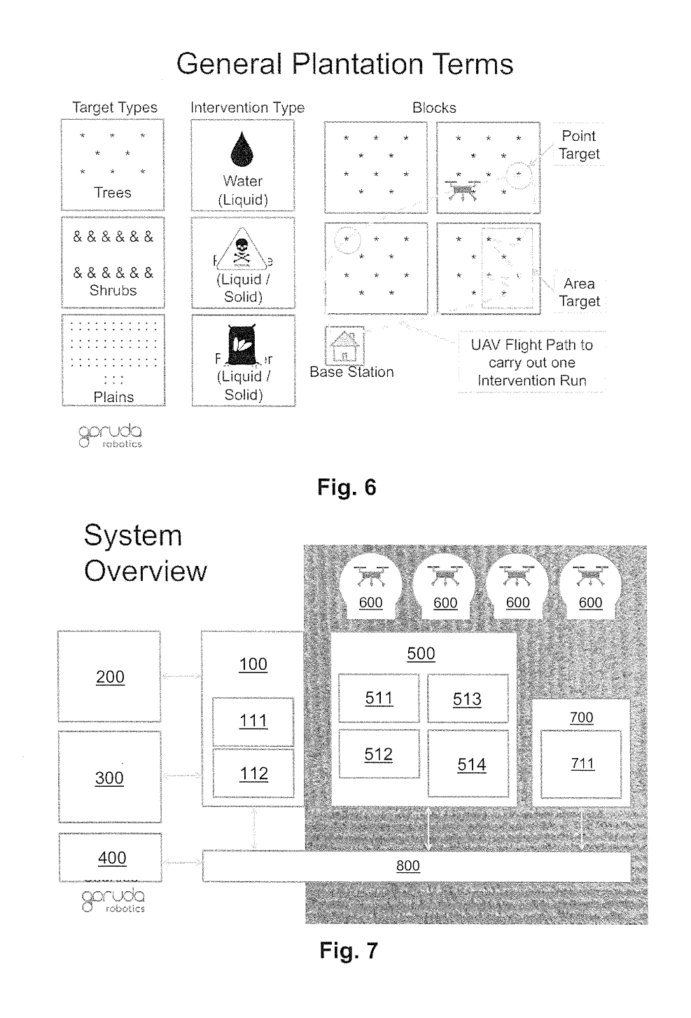

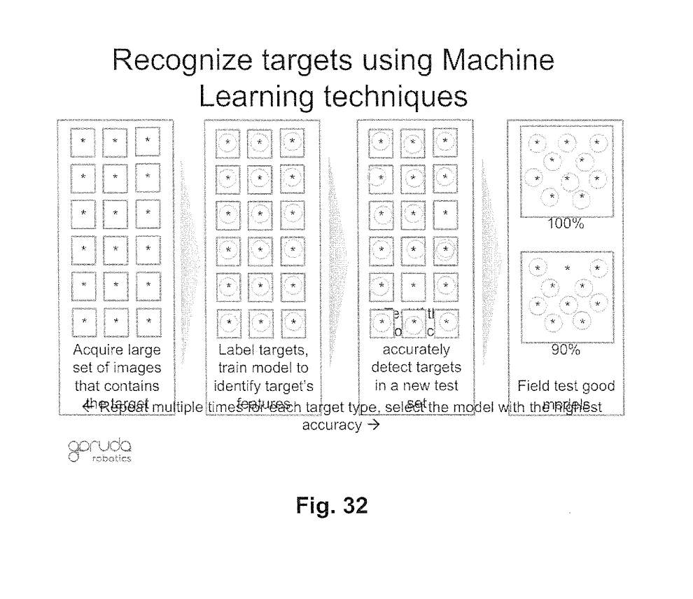

FIGS. 6 to 34 provide other embodiments of the invention, specifically of the application of the unmanned vehicles (such as UAV) on the management and intervention of an agriculture plantation system. The agriculture plantation system further comprise ground vehicles and base stations which carry out targeted interventions in farms and plantations, most commonly by releasing precise amounts of fertilizers and pesticides over a specific zone in response to ground conditions, with minimal effect on adjacent areas. The agriculture plantation system enables automated operation of targeted interventions in a farm or plantation environment. With reference to FIGS. 6 to 34, the terms “intervene”, “intervention” and “intervening” refer to the use of a variety of autonomous and/or remotely-triggered behaviours by an UAV to safely and accurately deliver a payload, preferably precise amounts of fertilizers, pesticides and/or irrigation (e.g. water), in solid and/or liquid forms to one or more specific targets at one or more target destinations. Further with reference to FIGS. 6 to 34, “targets” include but are not limited to trees, plants, shrubs, bushes, grass, flowers, crops, plains or parts thereof, depending on the type of plant/crop cultivated at the target destination, while “target destinations” include but are not limited to farms, plantations, nature reserves, grass lands or portions thereof. Depending on the specific issue being addressed by the targeted intervention, the area of interest on or in a tree, shrub or plain may differ. For example, a targeted intervention against pests in an oil palm tree may require the spraying of liquid pesticide on the spear tip at the top of the crown (Point Target); a targeted intervention against nutrient deficiency in a rice field may require the discharge of solid fertilizer in powder form over a specified zone (Area Target).

According to the embodiment of the invention of FIGS. 6 to 34, the agriculture plantation system comprises a Main Computer System (i.e. central processor) 100 in data communication (which can be wired or wireless) with an Unmanned Vehicles Command and Control (UVCC) System (server) 200, a Plantation Information Management System (PIMS) 300, external data sources 400 and mobile and static base stations 500.

### Main Computer System (100)

The main computer system or central processor 100 may comprise one or more servers, processors, and/or databases, distributed or otherwise, to achieve the following functions.

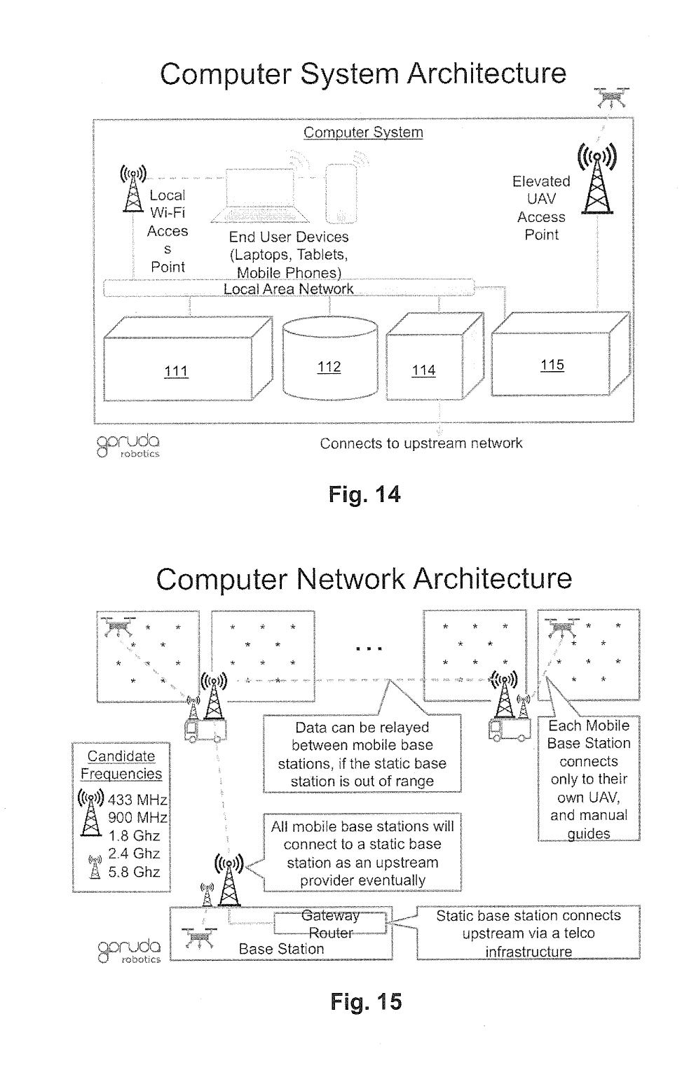

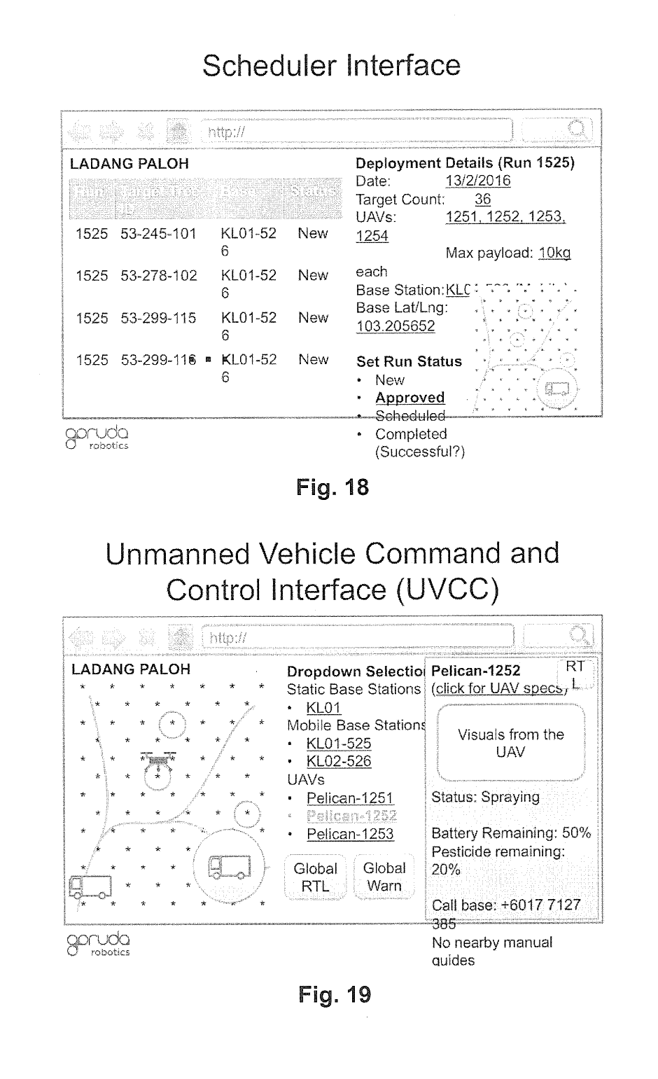

The Main Computer System 100 is a central coordinator of data, information sources and robotic vehicle resources. The Main Computer System comprises a master scheduler 111 (which can be web- or application-based) and a schedule database, hereinafter referred to as a master database 112. The master scheduler 111 plans and schedules all UAV operations and the generation of target areas for intervention by UAVs. The master scheduler 111 generates schedules (master schedules) where at least one schedule can be stored in the master database 112. An example of the scheduler interface on a mobile device of a pilot/agent is shown in FIG. 18. The agriculture plantation system can operate autonomously. However, a planned schedule can be overridden by a pilot/agent through via the scheduler interface. The Main Computer System 100 also communicates with external data sources (e.g. computer devices such as mobile devices) and the PIMS to determine a list of tasks for the next operating cycle (FIG. 14). The Main Computer System 100 also comprises a gateway router 114 and a communications module 115 for upstream or downstream communication. In summary, the computer system architecture enables one or more end users to communicate and transfer data from/to the UAVs.

### Plantation Information Management System (PIMS) (300)

The PIMS 300 may comprise one or more servers, processors, and/or databases, distributed or otherwise, to achieve the following functions.

The PIMS 300 acts as the central source of data about the plantation's operations and the single point of access to operational decisions such as plantation production targets, historical trends, etc. Agronomists/arborists may also use the PIMS to submit one or more electronic request for specific interventions at specific targets. Data on these targets (i.e. electronic requests) are transmitted to and received by the Main Computer System for processing in the present or next operating cycle. (FIG. 17). Such data or data set transmitted by the PIMS 300 comprises at least one of the following information related to the agricultural plantation: target, terrain, transportation route, planned locations of the plurality of base stations.

### Unmanned Vehicles Command and Control (UVCC) System/Server (200)

The UVCC 200 may comprise one or more servers, processors, and/or databases, distributed or otherwise, to achieve the following functions.

To efficiently carry out targeted interventions across a sizable area of farm land will require the use of multiple UAVs 600 and supporting Static and Mobile Base Stations 500. The UVCC 200 coordinates and manages the UAVs fleets and static and mobile base station fleets. In some embodiments, the UVCC 200 may be arranged in data communication with at least one base station. In some embodiments, the at least one base station 500 may be arranged in data communication with other processors/servers (including the UVCC 200) via a communication infrastructure. An example of the UVCC interface is shown in FIG. 19 which may be displayed on one or more mobile devices. Regardless of their status or position, UAVs 600 are consistently broadcasting telemetry data through the communication infrastructure to static and mobile base stations. Static and mobile base stations are consistently broadcasting their own telemetry data as well as the telemetry data of all their loaded UAVs back to the Main Computer System 100 and the UVCC 200. Periodic or continuous data synchronization between the Main Computer System 100 and the UVCC 200 and the UAVs 600 and base stations 500 ensure that the UAV and static/mobile base station telemetry data is made available to the Main Computer System 100 and UVCC 200 at all times. Telemetry data includes (but is not limited to) the position and heading of the UAVs 600 and static/mobile base station 500, as well as statuses of all electrical and mechanical systems/components (including the intervention delivery system). Via the UVCC Interface, a human operator (pilot/agent) may obtain a global picture of all operating and dormant units within the plantation compound. A human operator may also interrogate any unit for its status and telemetry data, view the live feed (if available) from its onboard camera or sensor systems, and command one or more units to return to base or perform an emergency position freeze. The UVCC 200 can comprise two separate coordination systems, one for the UAV fleet and the other for the mobile base station fleet.

### Unmanned Aerial Vehicle (UAV) (600)

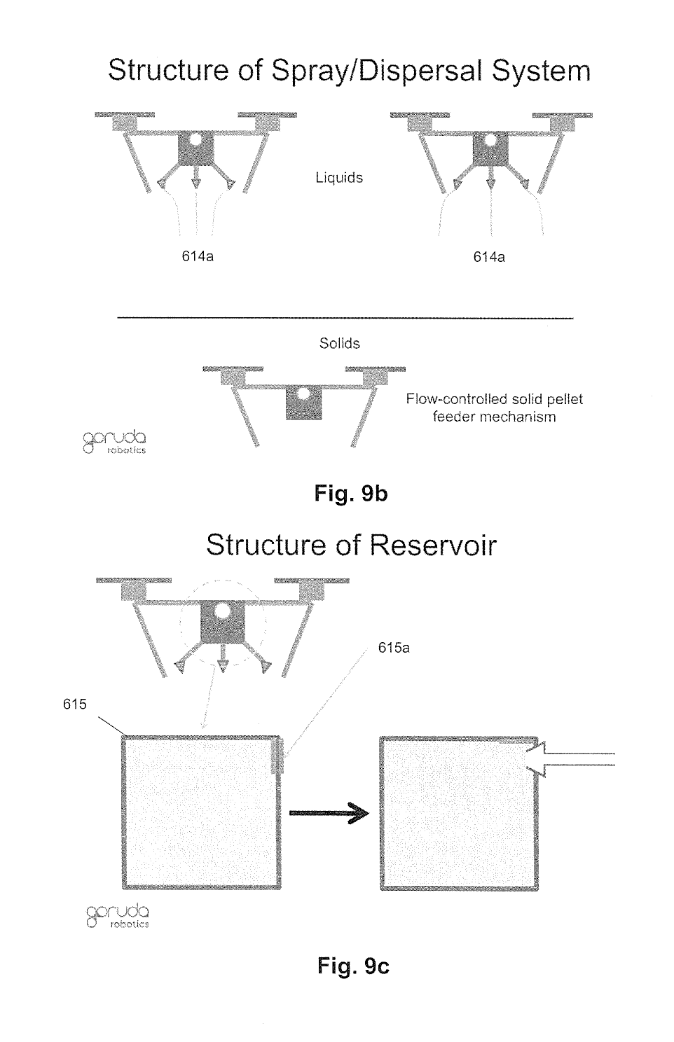

UAVs 600 are a multi-rotor vehicle or some variant comprising a propulsion system 611 that is capable of enabling flight in the UAVs and allow for the hovering of the UAVs 600 in the air over a given location. The UAVs of the present invention comprises a controlled release dispensing mechanism 614 which allows for dispersal of solids or spraying of liquids from a reservoir 615 onto a target below the UAV, and a camera system capable of capturing images and videos. FIGS. 9a to 9c illustrate a UAV of the present invention. The UAV 600 comprises an onboard processor and positioning and localization sensors 612 such as inertial measurement units and global navigation satellite systems such as GPS to enable UAV to execute autonomous flight. Given an appropriate data input captured by the UAV's onboard camera system, the UAV is capable of executing routines on the input and determine when the onboard solid or liquid payload should be released. Given a georeferenced base map of its assigned operating area, a list of targets with latitude and longitude coordinates, and knowledge of other important parameters such as its own operating capabilities (including but not limited to flying endurance and payload capacity), the UAV is able to plan a flight path in support of autonomous flying operation without the need for a human pilot. The UAV includes a wireless communication system/module (includes a communication link 613) enabling data transfer among the UAV, other UAVs or computer systems and/or the base stations.

The UAV's dispersal nozzles 614a are configured such that, upon dispersal of the intervention material, the solid or liquid substance will fall vertically downwards or towards the ground under the influence of gravity, depending on factors such as the angle of the nozzles, the weight of the material and prevailing wind/air conditions. If the payload is a liquid, it can be sprayed through the nozzle in a controlled manner under pressure towards the point target or target area. The flow-controlled nozzles 614a of the UAV can be shaped and/or arranged pointing inwards for controlled spraying of point targets while such nozzles 614a can be shaped and/or arranged pointing outwards for controlled spraying of area targets. The dispensing mechanism can comprise a centre nozzle for other surrounding nozzles to take reference to.

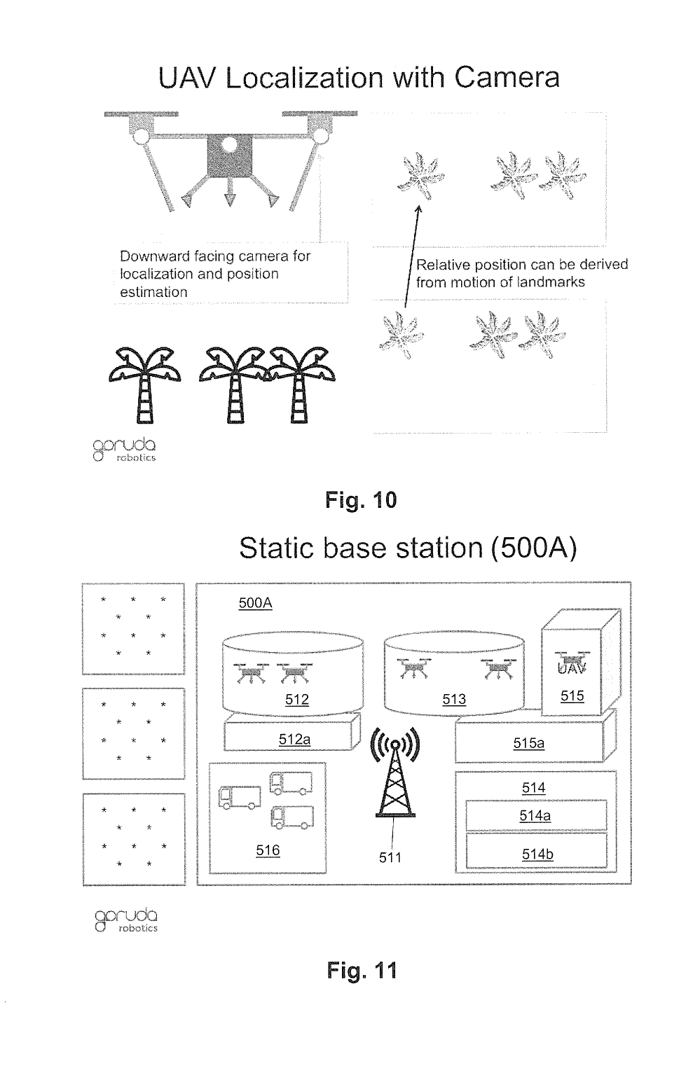

An embodiment of the UAV reservoir/tank 615 is shown in FIG. 9c. The UAV reservoir 615 comprises a one-way collapsing closure 615a installed into one wall of the container. In normal use, the spring-loaded closure exerts pressure against the opening and maintains a watertight seal preventing liquid leakage in flight. During the automated (or manual) refilling process, the external pressure exerted by a refilling nozzle on the spring-loaded door causes it to collapse upwards/inwards, exposing the refilling port and allowing for liquids and solids to be pumped into the reservoir. The UAV's on-board processor is capable of performing position estimation and localization of the UAV 600 using information from the camera system. By tracking the motion of key features or landmarks across a sequence of image frames, changes in position of the UAV can be estimated. Given an absolute location as a starting point, the absolute position of the UAV 600 at the end of the image frame sequence can also be estimated. (FIG. 10)

### Base Stations (500)

A typical farm and plantation can be too large for a single or several UAVs 600 to traverse efficiently in a single flight. To enable efficient deployment of the UAVs, the farm or plantation compound 113a is partitioned/segregated into individual discrete blocks 113b where each block 1113b may comprise an associated base station. For the purpose of simplifying the management of interventions within the plantation, the plantation area/compound 113a is divided into discrete management blocks using a block segregator installed with a dynamic partitioning algorithm that accounts for distribution of plants, terrain, distribution of base stations, and other factors. This may not always coincide with the division of blocks used by the plantation operator.

The block segregator may include servers and database arranged in data communication with one or more of the base stations 500, the PIMS 300, UVCC 200, central computer 100, and one or more UAV 600 to receive data relating to the terrain, area, target images, size, and/or location of the plantation area to be sent to the block segregator as inputs. The inputs will be processed by a partition algorithm to produce an output related to the division of the agricultural plantation into a plurality of smaller areas. In some embodiments, the block segregator further comprise an optimizer operable to minimize the total number of smaller areas to be segregated. The input and output relationship may be modelled as a scheduling and optimization problem based on a single objective function to minimize total partitions, or may include multi-objectives depending on applications.

The partitioning algorithm and/or optimizer is executed at the start of each operating cycle, and optimizes the use of UAV units by intelligently matching available UAVs and intervention targets on the ground to minimize parameters such as total flying time (FIG. 13). It will be appreciated that one or more of the partitioned blocks may have arbitrary shapes and sizes. Each partitioned block may have a different shape and size from one another, and the blocks may be contiguous or may overlap with one another. Segregating the plantation into blocks 113b improves efficiency of the system where the UAVs may consume less resources and take less time in delivering their payloads. This translates into better resource management and can reduce complexity in the components of the agriculture plantation system. For example, the UAVs may require a smaller battery (i.e. power source) to operate since their flight path can be confined to the blocks which allows for lighter and more efficient UAVs to be used in the agriculture plantation system. Segregation and partitioning of the plantation can also improve accuracy of the land data for the training of the UAVs for each operating cycle and allows for more precise recognition and locating of the targets in the plantation.

The base stations 500 may be static or mobile base stations. A base station comprises
a communications system 511 for communicating with UAVs, mobile devices, other base stations and the Main Computer System 100 and UVCC 200;
a launch/recovery platform that may be integrated with a power re-charging mechanism 512 in connection with a power source 512a, refilling mechanism 513 and storage 515 for supplies 515a (include but are not limited to water, fertilizers and pesticides), to prepare a UAV 600 for its next flight after it has landed; and
a local computer system (onboard processor) 514 that runs a local scheduler 514a.

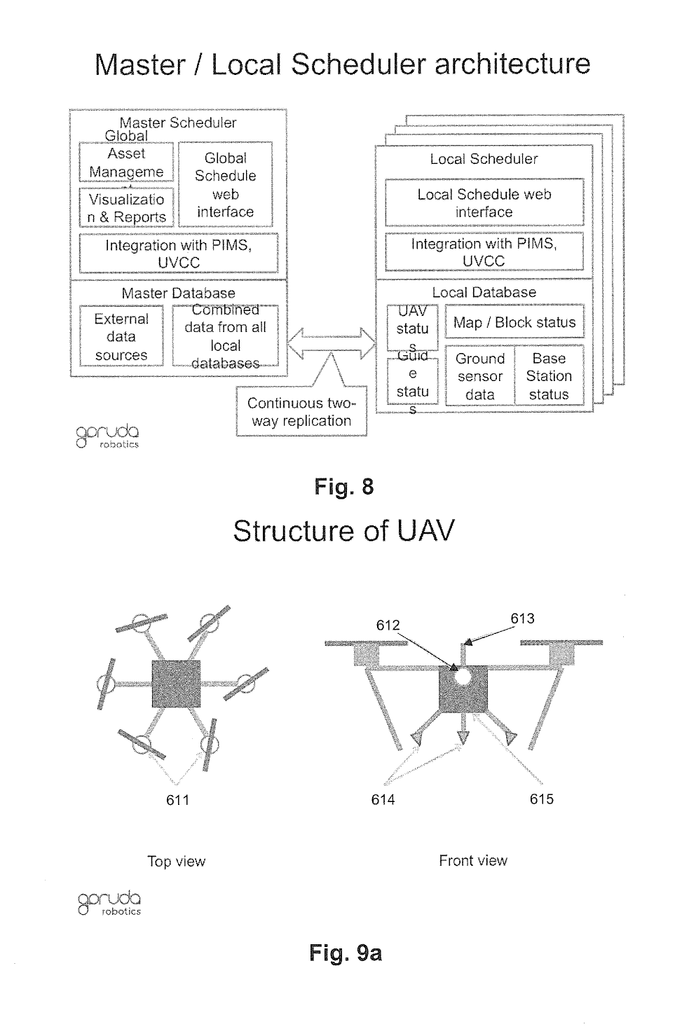

The local scheduler 514a copies, stores and maintains a copy of a master schedule, in a local database 514b so that it can create tasking instructions for the UAVs it communicates with (FIG. 8). The local computer system 514 can be in data communication with additional data sources such as weather stations and ground sensors to receive information about environmental conditions.

A static base station 500A is illustrated in FIG. 11. A static base station 500A is intended to be fixed in place at a particular location, and one or more static base stations 500A may be located at various locations in the plantation. In addition to the above, a static base station further comprises facilities 516 for storage of mobile base stations 500B and UAVs 600. Accordingly, a static base station can be a headquarter for deploying and returning mobile base stations.

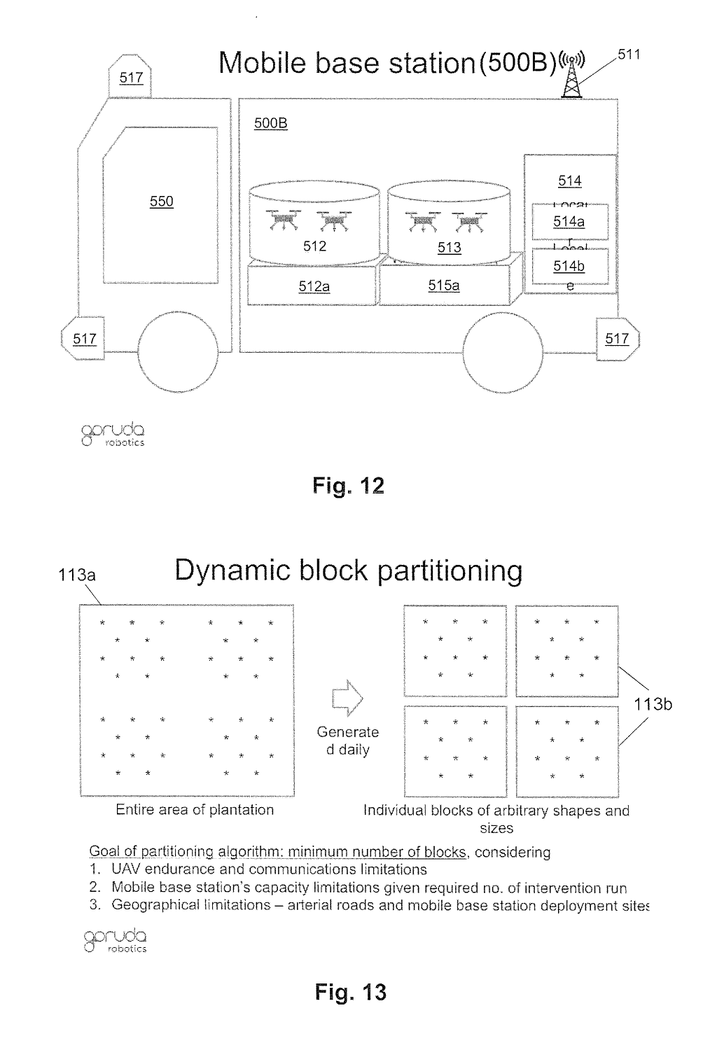

A mobile base station 500B is illustrated in FIG. 12. A mobile base station 500B performs the functions of a static base station 500A, but can be deployed in a remote location. Because of its mobility, it has a reduced capacity for UAV storage and launch/recovery/refuelling/refilling pods/mechanisms. Preferably, a mobile base station 500B is mounted on a vehicle such as a truck 550 which can be operated by a driver or autonomously by a ground vehicle controller and coordinated by the UVCC 200. When operated autonomously, the vehicles 550 on which the mobile base stations 500B are mounted can comprise additional object detection sensors 517 such as a sense and avoid system.

A combination of static and mobile base stations 500 can be used in the intervention of a plantation. However, it is appreciated that depending on application, only static or only mobile base stations 500 may be used instead. Where only mobile base stations 500B are used, the agriculture plantation system can comprise a storage facility for storage and replenishment of resources of the mobile base stations 500B and UAVs 600. Such storage facility can comprise a communication infrastructure for data communication with the mobile base stations 500B, the Main Computer System 100 and UVCC 200.

### Mobile Device (700)

Working alongside the UAVs 600 and Base Stations 500 are human workers (pilots/agents) who are involved with other tasks on the farm.

The human workers are equipped with mobile devices 700 that allow them to provide real-time corrective feedback and adjustments as the UAVs 600 are operating.

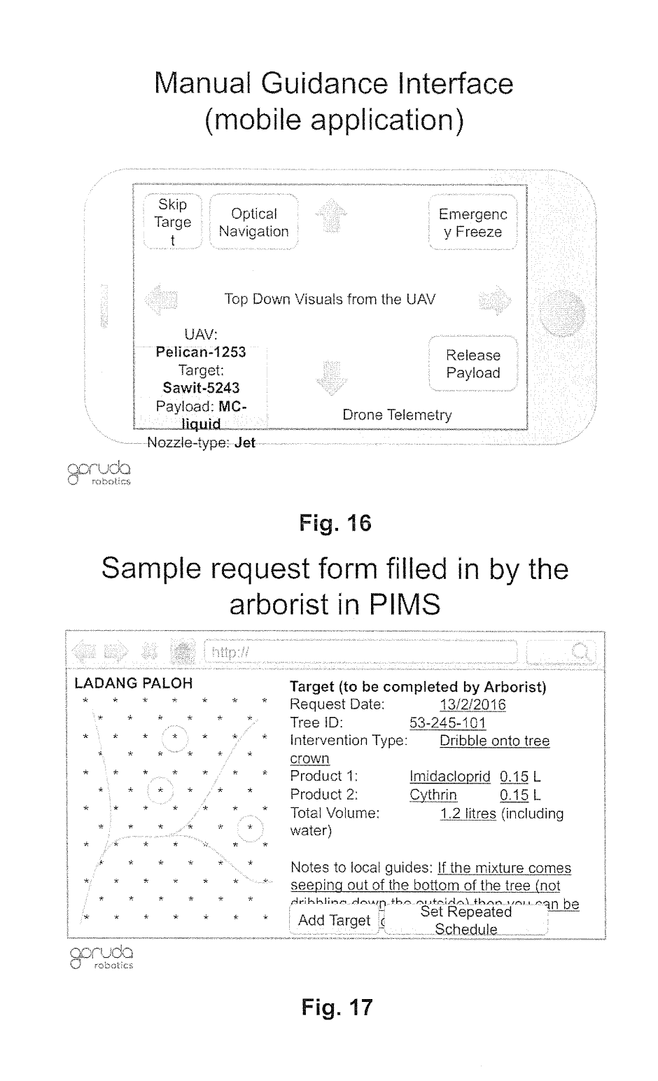

The mobile device 700 may be used to capture images of problem areas which can be submitted and subsequently used by the Main Computer System 100 to generate a new set of targets. In addition, human workers who are in the vicinity of a UAV 600 while it is performing an intervention may use the Mobile Device to provide adjustments to the dispersal process or trigger an emergency position freeze in case of safety violations. A manual guidance application interface for a human work to manually control a UAV is illustrated in FIG. 16.

The mobile device 700 comprises a communications system/module 711 for data communication with other components of the agriculture plantation system via communication infrastructure 800.

### Airspace Management and Air Traffic Control Module

Coordination of UAV unit movement is critical for safe, continued operation of the system. The agriculture plantation system comprises an airspace management and air traffic controller module in data communication with the base stations and UAVs (also known as airspace manager). The Airspace Management and Air Traffic Control module may comprise one or more servers, processors, and/or databases, distributed or otherwise, to achieve the following functions.

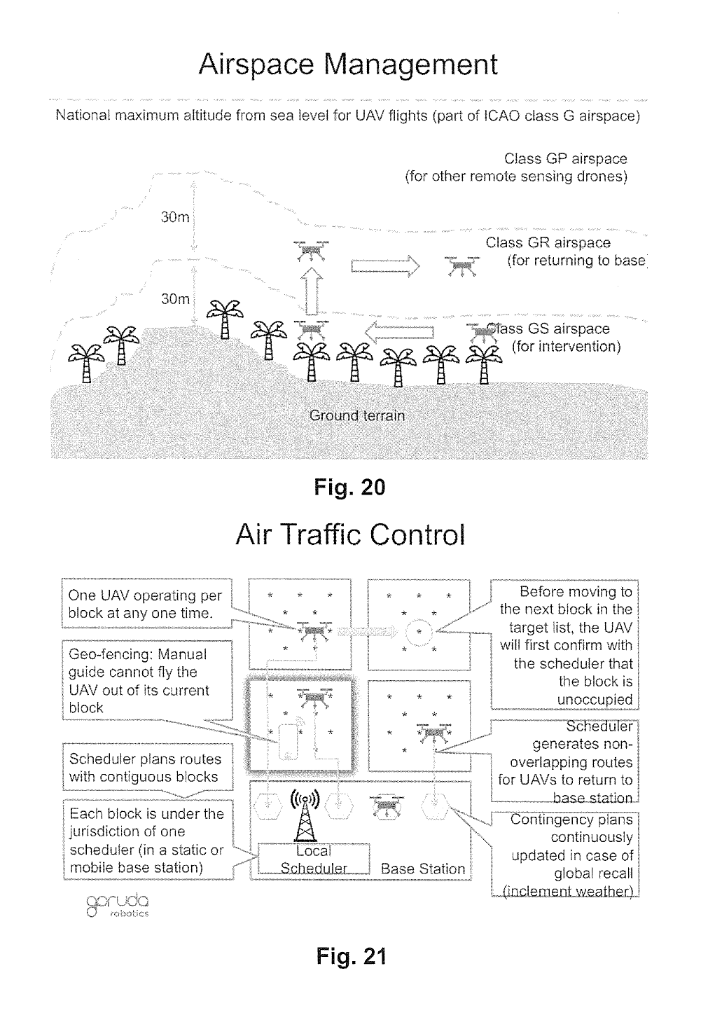

The airspace manager adopts an airspace segregation strategy, with distinct airspace classes (corresponding to preset altitude bands) allocated to various uses. All altitudes are “Above Ground Level (AGL)”, as measured from the ground terrain level (FIG. 20).

“Class GS” or a first airspace is allocated to all UAVs beginning or continuing to carry out targeted interventions over the plantation. This airspace class begins at the ground terrain level and extends to an altitude X meters higher than the tallest tree or shrub present in that plantation, where X represents the minimum desired separation between the UAV and said tree or shrub, plus a predetermined buffer zone height to the next higher airspace class.

“Class GR” or a second airspace is allocated to all UAVs that have completed their interventions and are in the process of returning to their static or mobile base stations for recovery and refuelling/refilling if needed. This airspace class begins at the upper limit of the “Class GS” airspace and occupies Y meters, where Y is chosen to provide sufficient altitude for UAVs to recover from any sudden wind gusts and other environmental perturbances encountered in flight without infringing on other airspace classes.

“Class GP” or a third airspace begins at the upper limit of the “Class GR” airspace and extends to the maximum altitude permitted for UAV operations in that location (for example, the limit for the International Civil Aviation Organization (ICAO) Class G uncontrolled airspace for a plantation situated in such a location). “Class GP” airspace may be allocated for other remote sensing UAVs.

The airspace manager allocates distinct zones for incoming and outgoing UAVs. It also separates UAVs operating under nominal conditions and those encountering a potential emergency situation.

The base stations 500 comprise the air traffic controller. Therefore within a single operating block, air traffic control is handled by the base stations. Only one UAV 600 may operate in a given block 113b at any one time, thereby avoiding the problem of having to coordinate the actions of multiple UAVs within a confined region of airspace (FIG. 21). Individual UAVs are subject to geo-fencing restrictions imposed on board the UAV's flight controller and based on information from a global navigation satellite system such as GPS. The air traffic controller receives scheduling data relating to the targets of each UAV from the local scheduler. The local scheduler plans routes with contiguous blocks where each block is under the jurisdiction of one local scheduler. In the event that a UAV needs to move from one block to another, the Local Scheduler in the blocks' controlling Base Station (whether Static or Mobile) acts as an arbiter. The UAV will query the Local Scheduler to determine whether the desired next block is free of UAVs. If this is confirmed, it can proceed to occupy the next block and continue intervening at its next target. The local scheduler also generates non-overlapping routes for UAVs to return to the base stations. Further, contingency plans are continuously updated in case of global recall of the UAVs (for example due to inclement weather).

### Ground Traffic Control Module

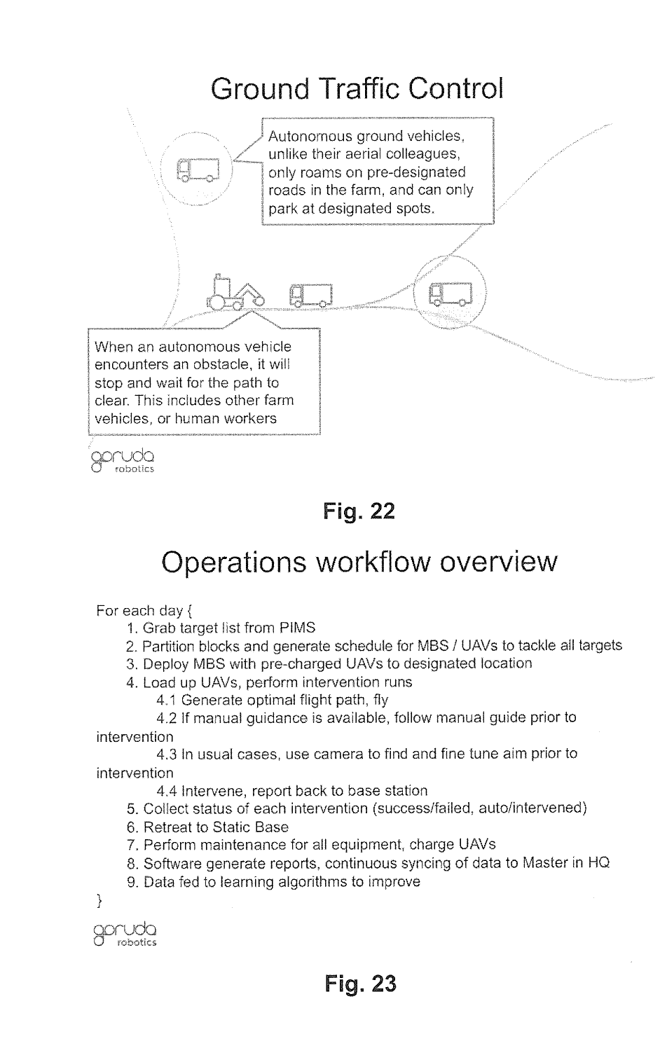

The Ground Traffic Control module may comprise one or more servers, processors, and/or databases, distributed or otherwise, to achieve the following functions. The ground traffic control system enables the tracking and tasking of ground vehicles such as the mobile base stations (FIG. 22). In the event that human-driven mobile base stations are used, the ground traffic control system serves primarily to track and monitor the movements and positions of the vehicles. In the event that autonomous ground vehicles (autonomous mobile base stations) are used, the ground traffic control also generates tasking instructions for the autonomous ground vehicles as they move to their assigned locations within an operating cycle.

The ground traffic control maintains a map of all passable roads and tracks within the farm compound, as well as designated parking areas that have been set aside for mobile base stations to deploy.

### Computer Network Infrastructure

As illustrated in FIG. 15, data is communicated and/or synchronized across all components in the agriculture plantation system by a compound-wide computer network infrastructure (i.e. network operator) 800. The computer network infrastructure 800 can be a wireless network, wired network or a combination of wired and wireless networks. Preferably, the computer network infrastructure is a wireless network.

Connectivity from the internal communications network to external computer systems is provided via a wireless or wired telecommunications link through Wi-Fi, 3G/4G, GPRS, LTE and/or standard telco infrastructure.

Within the plantation/compound, communications links may be formed in a few ways: from mobile UAV units 600 directly to fixed base stations, from mobile UAV units 600 directly to mobile base stations 500, and between UAV units 600 while utilizing intermediate stations to relay information in the absence of a direct link. Communication links may also form between base stations 500.

Mobile base stations 500 maintain a direct, always-on connection to their assigned UAVs 600 and mobile devices 700 within their operating blocks that are authorized to take mediated control of UAVs during an intervention. UAVs 600 generate and synchronize collected data to transmit to their base stations 500.

Mobile base stations 500B preferably maintain a direct, always-on connection with a static base station 500A. In the event that this is not possible because the nearest static base station 500A is out of range, a mobile base station 500B may attempt to connect to a nearby mobile base station 500B that has a connection to a static base station 500A and request that information be relayed to the Main Computer System 100. The Main Computer System 100 may be in direct communication with all of the base stations 500 or may communicate with mobile base stations 500B via one or more static base stations 500A.

### Workflow (Method for Managing an Agriculture Plantation)

At the beginning of each operating cycle (typically one day), the Main Computer System follows a preset workflow to plan, schedule and execute intervention activities in the farm compound (FIG. 23). After interventions have been completed, information is collected from various data sources, including the UAVs, reports via mobile devices carried by human workers, and requests from plantation management workers for the next cycle.

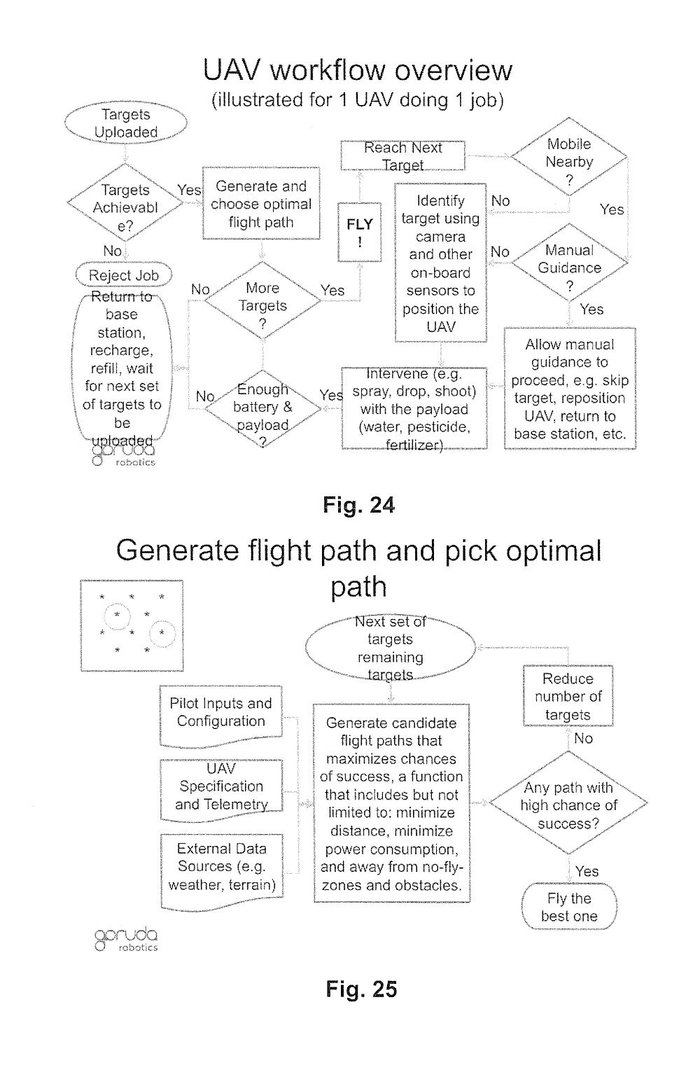

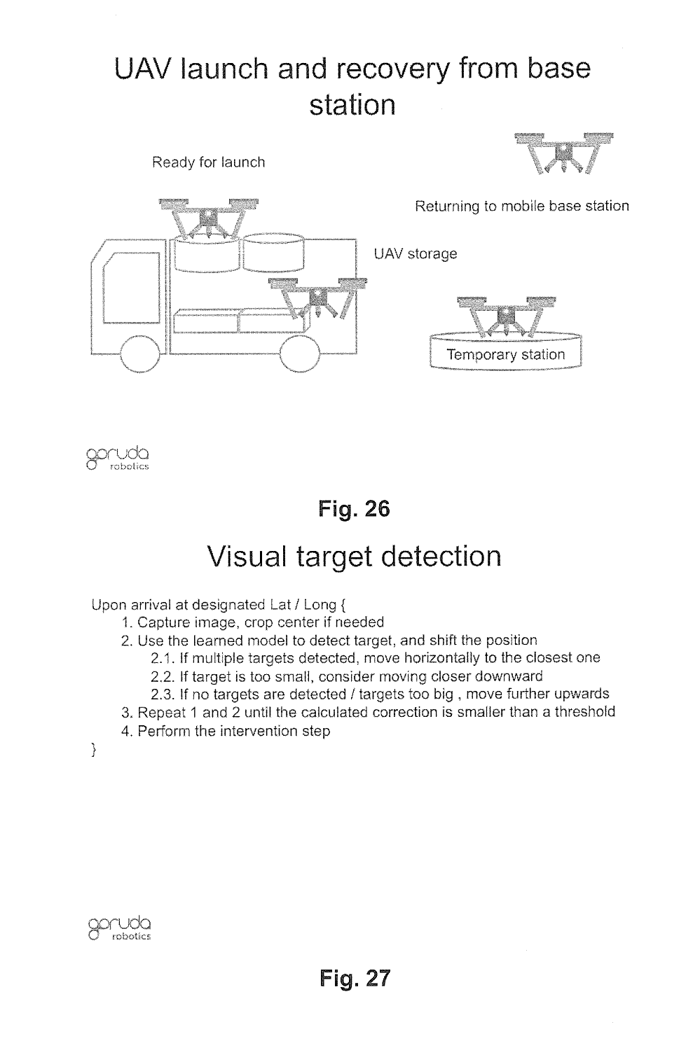

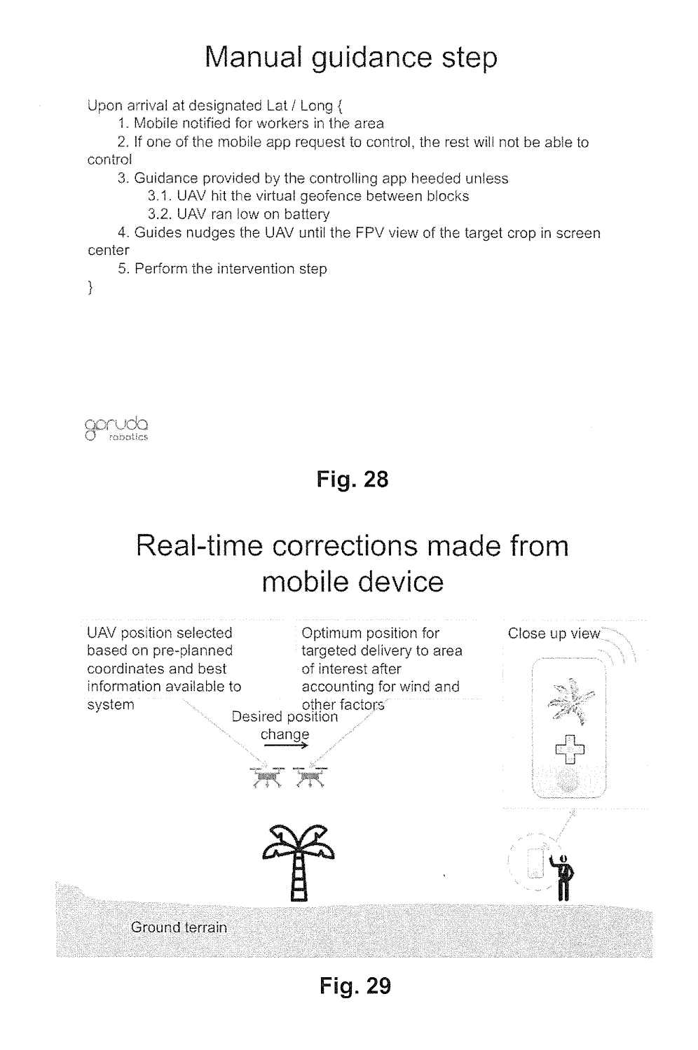

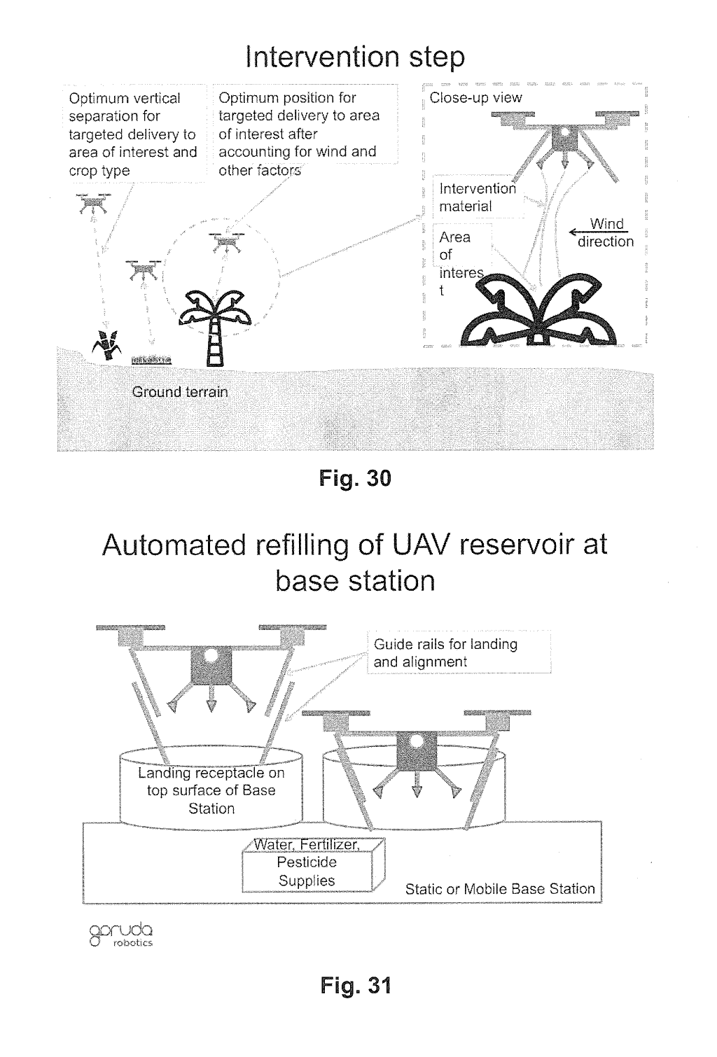

The workflow proceeds as follows:
1. The Main Computer System queries the PIMS for a list of targets that are active within the intervention cycle.
2. The compound block partitioning algorithm (block segregator) is executed in order to generate a spatial division of land that supports efficient deployment of UAVs and mobile base stations.
3. The master scheduler generates a tasking schedule with instructions for all UAVs and mobile base stations involved in the current cycle's interventions.
4. Mobile base stations and UAVs are prepared for deployment. In order to improve efficiency, refuelling, battery charging, material refilling and any other time-consuming activities may be initiated ahead of time, prior to the arrival and receipt of the tasking schedule from the master scheduler by the base stations.
5. Once a mobile base station and its associated load of UAVs is ready, it is deployed to its assigned location.
6. UAVs will be loaded onto launch platforms and launched according to their assigned schedule. Once a UAV has been loaded, it will receive a list of assigned targets and assess its ability to successfully intervene (based on its flying and material carrying capabilities) (FIG. 24).
7. If a UAV determines that it can successfully complete the assigned tasks, an optimal flight path will be generated (by the base station, UAV or UVCC) that enables it to visit all assigned intervention targets using the shortest possible flight, taking into account its flight capabilities, known specifications, and external data such as the terrain and weather conditions within its assigned block of operations (FIG. 25). In particular, the generation of an optimal flight path comprises utilizing at least one of the following as an objective function: minimize distance between the unmanned aerial vehicle and the target; minimize power consumption of the unmanned aerial vehicle; and subjected to the constraints of no-fly zones and obstacles. Once this process is complete, the UAV will launch and begin traversing its planned flight path. (FIG. 26)
8. During the flight, a UAV will follow its pre-planned route to the next target on its list. Positioning accuracy from standard global navigation satellite systems typically falls in the range of 3-10 m, assuming a clear view of sufficient satellites. To achieve more accurate positioning over a target area, the UAV will activate a visual target detection routine on its on-board computer processor once it is sufficiently close to the target coordinates. The UAV performs a lookup on the learned target model downloaded from the Main Computer System and performs a visual search for the specific target. The target model is built and generated by a machine-learning algorithm that is provided with images determined to be targets and determined not to be targets. This may take the form of, among other things, the centre of a tree that has a distinctive pattern or a patch of grass that is of a different colour due to nutrient or irrigation deficiencies (FIG. 27)
9. In certain scenarios, the UAV's visual target detection routine may be overridden by a human worker's mobile device. In this mediated control mode, a UAV will only take instructions from one mobile device at any time (FIG. 28). This mode allows for a human worker who is positioned close to the target area to provide real-time control feedback about the appropriate place for the intervention material to be dispersed. In this mode, the UAV's on-board camera transmits a live view of its camera feed to the controlling mobile device to assist the human worker. (FIG. 29)
10. Once the UAV has positioned itself accurately over the target area, it will carry out the desired intervention by releasing, dispersing or spraying the required amount of solid or liquid material onto the point target or over the target area (FIG. 30).
11. In the event that wind conditions noticeably affect the trajectory of the dispersed material, a human worker may take control of the UAV to adjust the dispersal location. If the wind conditions are known to the mobile device, static base station, mobile base station or Main Computer System, a positioning correction may also be generated by any of these systems to move the UAV to a better location for the intervention (FIG. 30).
12. Once an intervention has been attempted and/or completed, the UAV proceeds to its next target. When all targets on its list have been attempted, the UAV returns to its assigned base station.
13. Once the UAV has landed at a base station, it reports on the status of each intervention based on its recorded camera feeds and visual confirmation obtained through processing of said feeds. The block segregator is arranged in data communication with the UAVs to receive at least one image relating to the geographical surrounding the UAVs operate within. Additional reports on the success or failure of each intervention may also be submitted by human workers in the vicinity of the operation block using their mobile device. Gathered images from UAVs and/or mobile devices can be stored in a target image database. The target image database is operable to store a plurality of images determined to be visually similar to at least one target and/or a plurality of images determined not to be targets. These images can be used by the machine-learning algorithm to generate an internal model of the target. With more operation cycles, more images are gathered and this iterative process improves the target model and enhances target recognition by the UAV for increased accuracy and precision of flight and payload delivery.
14. A UAV may have to perform multiple flights. The master scheduler may explicitly generate assignments for multiple flights for a particular UAV, or the UAV's automated path planning process may decide to perform more than one flight to complete its assigned list of targets.
15. If multiple flights are required by a UAV, it will be returned to its assigned base station in between flights for automated recovery, refueling and refilling. In the event that no automated launch/recovery platforms are available at its assigned Mobile Base Station, a UAV may choose or be instructed to land at a temporary launch/recovery platform (FIG. 31).
16. After all assigned activities have been carried out to a satisfactory degree, the base station are loaded up with all their assigned UAVs and the mobile base stations return to a static base station or a storage facility.
17. All UAVs and base stations undergo maintenance, refuelling and refilling in preparation for the next operating cycle.
   All data collected is synchronized to the Main Computer System in the headquarters of the farm/plantation, and reports are generated as needed. Data is also used to train visual target detection routines and other algorithms ahead of the next operating cycle (FIG. 34).

It should be further appreciated by the person skilled in the art that variations and combinations of features described above, not being alternatives or substitutes, may be combined to form yet further embodiments falling within the intended scope of the invention. In particular,
The Main Computer System, UVCC, PIMS and external data sources may be at a location near, far or at the target destinations.
The Main Computer System, UVCC, PIMS may be located and integrated in a base station.
The unmanned vehicles include but are not limited to aerial, ground and submersible vehicles depending on the application and the relevant dispersion system in such unmanned vehicles will be adapted accordingly. The various components of the system of the present invention may also be adapted accordingly depending on the application. Further, the system of the present invention can control a combination of aerial, ground and submersible unmanned vehicles.
The number of regions and their distances as segregated by the airspace management and air traffic controller module depends on application. There can be a varying number of regions and the distances in each region can differ from one another.
The mobile device utilized by a pilot/agent/human individual can be a static device such as a computer device that is immobile.

1. A system for managing an agriculture plantation comprising
a plantation information management server operable to send at least one electronic request to manage the agricultural plantation, the at least one electronic request comprises at least one target within the agricultural plantation;
a central processor arranged in data communication with the plantation information management server to receive the electronic request to form a first dataset; the first dataset comprises data related to a size, a location and the at least one target within the agricultural plantation;
an unmanned vehicle command and control server arranged in data communication with a plurality of base stations to deploy the plurality of base stations at predetermined locations within the agricultural plantation; each of the plurality of base stations arranged in data communication with at least one unmanned vehicle; the unmanned vehicle command and control server further arranged in data communication with the central processor to receive a second dataset related to at least one operation of the at least one unmanned vehicle; and
a block segregator arranged to receive the first dataset as input to generate an output, the output comprises data related to the division of the agricultural plantation into a plurality of smaller areas.

2. The system according to claim 1, wherein the first dataset further comprises at least one of the following information related to the agricultural plantation: terrain, transportation route, planned locations of the plurality of base stations.

3. The system according to claim 1, wherein the block segregator is configured to optimize the number of smaller areas.

4. The system according to claim 1, wherein the at least one of the unmanned vehicle is an unmanned aerial vehicle.

5. The system according to claim 1, wherein at least one of the plurality of base stations is a mobile base station and at least one of the plurality of base stations is a static base station.

6. The system according to claim 5, wherein the static base station is deployed within one of the plurality of smaller areas and arranged in data communication with the mobile base station.

7. The system according to claim 1, wherein the central processor is arranged in data communication with a schedule database, the schedule database operable to store at least one schedule related to the at least one operation of the at least one unmanned vehicle.

8. The system according to claim 4, further comprises an airspace management and air traffic control module arranged in data communication with the plurality of base stations and the at least one unmanned aerial vehicle.

9. The system according to claim 8, wherein the airspace management and air traffic control module is operable to segregate the region which the at least one unmanned aerial vehicle operates within into a plurality of airspaces.

10. The system according to claim 9, wherein the plurality of airspaces comprises a first airspace measured from ground level to a reference point plus a first predetermined distance above the reference point.

11. The system according to claim 10, further comprises a second airspace extending by a second predetermined distance above the first airspace.

12. The system according to claim 11, further comprises a third airspace extending by a third predetermined distance above the second airspace.

13. The system according to any one of claims 9 to 12, wherein the at least one operation of the at least one unmanned aerial vehicle comprises dropping a payload over an area or an object within the smaller area.

14. The system according to claim 13, wherein the plurality of base stations are operable to receive information relating to the plurality of airspaces to control the at least one unmanned aerial vehicle within the first airspace to drop the payload.

15. The system according to claim 14, wherein the base station is operable to control the UAV to operate within the second airspace after dropping the payload to return to the base station.

16. The system according to claim 1, wherein the block segregator is arranged in data communication with at least one of the plurality of unmanned vehicle to receive at least one image relating to the geographical surrounding the unmanned vehicle operates within.

17. The system according to claim 6, wherein there comprises a plurality of mobile base stations, each mobile base station operable to data communicate with other mobile base stations.

18. The system according to any one of the preceding claims, wherein the data communication between the unmanned vehicle command and control server and the plurality of base stations is facilitated via a network operator.

19. The system according to any one of the preceding claims, further comprises a mobile device arranged in data communication with the unmanned vehicle to control the at least one unmanned vehicle near the vicinity of the at least one target.

20. The system according to claim 1, further comprises a target image database to store a plurality of images determined to be visually similar to the at least one target.

21. The system according to claim 20, wherein the target image database is operable to store a plurality of images determined not to be targets.

22. The system according to claims 20 and 21, wherein the plurality of images determined to be targets and determined not to be targets is fed as an input dataset into a machine-learning algorithm to build an internal model of the target.

23. An unmanned aerial vehicle for use with the system of claim 1, comprising
a propulsion device operable to move the unmanned vehicle,
a communication module operable to facilitate data communication between the unmanned aerial vehicle with at least one of the base stations,
an image capturing device operable to capture image;
a payload storage tank; and
a payload dispensing mechanism.

24. The unmanned aerial vehicle according to claim 23, wherein the payload dispensing mechanism is shaped and adapted to dispense at a point target or an area target.

25. The unmanned aerial vehicle according to claim 24, wherein the payload dispensing mechanism comprises a plurality of nozzles taking reference to a centre nozzle.

26. The unmanned aerial vehicle according to claim 25, wherein the plurality of nozzles are pointed towards the centre nozzle for releasing a fluid payload at the point target.

27. The unmanned aerial vehicle according to claim 25, wherein the plurality of nozzles are pointed outwards from the centre nozzle for releasing a fluid payload at the area target.

28. A static base station according to claims 5 or 6 and 7, further comprises a recharging pod, a refill pod, a payload supply, a communication device for data communication with at least one mobile base station and the unmanned vehicle command and control server, and a processor server in data communication with the schedule database.

29. A mobile base station according to claims 5 or 6 and 7, further comprises a recharging pod, a refill pod, a payload supply, a communication device for data communication with at least one unmanned aerial vehicle, and a processor server in data communication with the schedule database.

30. A method for managing an agriculture plantation comprising the steps of:
receiving from a plantation information management server, at least one electronic request to manage the agricultural plantation, the at least one electronic request comprises at least one target within the agricultural plantation;
forming a first dataset; the first dataset comprises data related to a size, a location, and the at least one target within the agricultural plantation;
generating, based on the first dataset as input, an output, the output comprises data related to the division of the agricultural plantation into a plurality of smaller areas;
sending a second dataset to an unmanned vehicle command and control server, the second dataset related to at least one operation of at least one unmanned vehicle; and
deploying, via the unmanned vehicle command and control server, a plurality of base stations at predetermined locations within the agricultural plantation; each of the plurality of base stations arranged in data communication with at least one unmanned vehicle.

31. The method according to claim 30, wherein the first dataset further comprises at least one of the following information related to the agricultural plantation: terrain, transportation route, planned locations of the plurality of base stations, actual location of at least one of the plurality of base station.

32. The method according to claim 30, further comprising the step of optimizing the number of smaller areas.

33. The method according to claim 30, further comprises the step of generating a schedule based on the at least one target within the agricultural plantation, and storing the generated schedule by a schedule database.

34. The method according to claim 33, further comprises an airspace management and air traffic control module arranged in data communication with the plurality of base stations and the at least one unmanned aerial vehicle.

35. The method according to claim 34, further comprising the step of segregating, by the airspace management and air traffic control module, the region which the at least one unmanned aerial vehicle into a plurality of airspaces.

36. The method according to claim 35, wherein the plurality of airspaces comprises a first airspace measured from ground level to a reference point plus a first predetermined distance above the reference point.

37. The method according to claim 36, further comprises a second airspace extending by a second predetermined distance above the first airspace.

38. The method according to claim 37, further comprises a third airspace extending by a third predetermined distance above the second airspace.

39. The method according to claim 30, further comprising the step of loading a plurality of unmanned aerial vehicles and generating an optimal flight path after the step of deploying the plurality of base stations.

40. The method according to claims 31 and 36, further comprising the step of moving the unmanned aerial vehicle within the first airspace to the at least one target.

41. The method according to claim 40, further comprising the step of locating, by an image capturing device mounted on the unmanned aerial vehicle, the at least one target.

42. The method according to claim 41, further comprising the step of releasing a payload on the at least one target.

43. The method according to claim 42, further comprising the step of collecting a status associated with the release of payload.

44. The method according to claims 37 and 43, further comprising the step of moving the unmanned aerial vehicle into the second airspace, and moving away from the target and towards the base station after the step of releasing the payload.

45. The method according to claim 44, further comprising the step of maintaining the unmanned aerial vehicle.

46. The method according to claim 43, further comprising the step of generating and synchronizing collected data to be sent to the base station.

47. The method according to claim 39, wherein the step of generating the optimal flight path comprises utilizing at least one of the following as an objective function: minimize distance between the unmanned aerial vehicle and the target; minimize power consumption of the unmanned aerial vehicle; and subjected to the constraints of no-fly zones and obstacles.
